(19) United States
(12) Patent Application Publication
(10) Pub. No.: US 2009/0094626 A1
(43) Pub. Date: Apr. 9, 2009

(54) INFORMATION PROCESSING DEVICE AND METHOD, AND PROGRAM

(75) Inventor: Akio TERADA, Kanagawa (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/237,773

(22) Filed: Sep. 25, 2008

(30) Foreign Application Priority Data
Oct. 3, 2007 (JP) JP2007-259925

(51) Int. Cl. G11B 7/00

(52) U.S. Cl. 720/659; 372/38.02

(57) ABSTRACT

An information processing device for performing calibration of an optical output level control unit for controlling the optical output level of a laser beam which an emission unit emits by multiple channels controlling the current value of current supplied to the emission unit for emitting a laser beam with an optical output level according to the current value, includes a calibration unit for performing calibration processing for each of the multiple channels of the optical output level control unit wherein the emission unit is controlled to emit the laser beam with multiple different optical output levels, the optical output level control unit is controlled to detect the indicating value of the current value corresponding to each optical output level, the relation between the indicating value and the optical output level is obtained, and an indicating value corresponding to a target optical output level is adjusted according to the relation.

### CROSS REFERENCES TO RELATED APPLICATIONS

The present invention contains subject matter related to Japanese Patent Application JP 2007-259925 filed in the Japanese Patent Office on Oct. 3, 2007, the entire contents of which are incorporated herein by reference.

### BACKGROUND OF THE INVENTION

1. Field of the Invention

The present invention relates to an information processing device and method, and program, and particularly relates to an information processing device and method, and program, whereby the calibration of control of the emission output level of a laser beam can be performed in a more precise manner.

2. Description of the Related Art

With a drive device or the like of a recordable optical disc, writing or reading of information is performed by irradiating a laser beam on an optical disc, but control of emission power (optical output level) is performed with an APC (Auto Power Control) circuit such that the emission power (optical output level) of the laser beam at that time becomes an appropriate value.

Of a laser beam, appropriate values differ mutually regarding read power (read optical output level) which is emission power when reading out information recorded in an optical disc, cool power (cool optical output level) which is emission power when cooling an optical disc surface, erase power (erase optical output level) which is emission power when erasing information recorded in an optical disc, and peak power (peak optical output level) which is emission power when writing information in an optical disc. The APC circuit controls the emission power in each state so as to obtain an appropriate value at a mutually different channel.

Such an APC circuit controls performs control of emission power by controlling the indicating value of a current value to be supplied to a laser diode based on the voltage level fed back by detecting (photoelectric-converting) a laser beam output from the laser diode.

In recent years, increase in density of optical discs, and increase in speed of writing processing and reading processing have advanced, and along therewith reduction in an allowable range (margin) of emission power has advanced. Accordingly, there has been demand for improvement in precision of control of emission power by the APC circuit.

Heretofore, even at the time of writing, control of emission power has been performed at all of the channels of cool power, erase power, and peak power, but with this method, handling as to increase in speed is difficult, and accordingly, in recent years, this method has not frequently been employed. In recent years, a method for controlling emission power at a part of channels, and indirectly controlling the other channels based on the relation between channels has become mainstream. However, in this case, there is a possibility that precision of emission power control may deteriorate.

Therefore, in order to improve precision of emission power control, there has been a method for performing control of emission power by performing detection of a laser beam multiple times, and employing the average value thereof (e.g., see Japanese Unexamined Patent Application Publication No. 03-295036, and Japanese Unexamined Patent Application Publication No. 07-181605).

Further, there has been a method for generating a parameter indicating the quality of operation based on the amplitude of a detected laser beam, and performing control of emission power based on the parameter thereof (e.g., see Japanese Unexamined Patent Application Publication No. 2006-527453).

Also, for example, there has been a method for performing calibration regarding control of erase power, and based on the calibration result thereof and the relation between the channels, performing calibration of control of other channels, thereby improving accuracy.

### SUMMARY OF THE INVENTION

However, precision of power settings obtained with those methods depends on precision of circuits and matching of precision. In recent years, in order to handle diversity regarding media types and double speed settings, it is desirable to increase the current in full scale, and consequently, there is a possibility that it is difficult to derive absolute precision with precision of circuits and matching of precision.

Particularly, in recent years, an arrangement has become mainstream wherein only the final stage is mounted on an OP (Optical Pickup) as an LDD (Laser Diode Driver), and an APC is mounted on a drive substrate. Thus, if an arrangement is made wherein a system for controlling optical output is configured of mutually separate multiple circuits, there is a possibility that with the entire system, it is difficult to derive absolute precision with circuit precision and matching of precision.

There has been found the desire to enable calibration of control of emission output level of a laser beam to be performed with higher precision.

According to an embodiment of the present invention, an information processing device for performing calibration of an optical output level control unit for controlling the optical output level of a laser beam which an emission unit emits and outputs by a plurality of channels controlling the current value of current supplied to the emission unit for emitting and outputting a laser beam with an optical output level according to the current value of the supplied current, includes a calibration unit configured to perform calibration processing for each channel regarding a part or all of the plurality of channels of the optical output level control unit wherein the emission unit is controlled to emit and output the laser beam with a plurality of different optical output levels, the optical output level control unit is controlled to detect the indicating value of the current value corresponding to each optical output level, the relation between the indicating value and the optical output level is obtained, and an indicating value corresponding to a target optical output level is adjusted in accordance with the relation.

The calibration unit may control the emission unit to emit and output the laser beam with a plurality of different optical output levels, control the optical output level control unit to detect the indicating value of the current value corresponding to each optical output level, obtain the relation between the indicating value and the optical output level based on the plurality of detection results, and obtain an indicating value corresponding to a target optical output level in accordance with the relation, for each channel as the calibration processing.

The calibration unit may control another channel of the optical output level control unit which is not a target for the calibration processing to control the current with the same indicating value as that in the case at the time of normal operation when performing the calibration processing.

The emission unit may be a laser diode for irradiating a laser beam on an optical disc mounted on a predetermined position of an optical disc drive device; with the optical output level control unit controlling a read optical output level which is the optical output level of the laser beam at the time of reading out information recorded in the optical disc, a cool optical output level which is the optical output level of the laser beam at the time of cooling the optical disc, an erase optical output level which is the optical output level of the laser beam at the time of erasing information recorded in the optical disc, and a peak optical output level which is the optical output level of the laser beam at the time of writing information in the optical disc, using mutually different channels; and with the calibration means calibrating the indicating value corresponding to the cool optical output level, the indicating value corresponding to the erase optical output level, and the indicating value corresponding to the peak optical output level, of the optical output level control unit by the calibration processing.

The calibration unit may perform the calibration processing before the emission unit starts reading processing or writing processing of the information as to the optical disc.

The calibration unit may control the optical output level control unit to detect the indicating value corresponding to the read optical output level.

The optical output level control unit may calculate the indicating value corresponding to the cool optical output level by subtracting the output of a predetermined D/A converter from the indicating value corresponding to the read optical output level at a channel for controlling the cool optical output level; with the calibration unit obtaining the indicating value corresponding to the cool optical output level, and further subtracting the indicating value corresponding to the cool optical output level thereof from the indicating value corresponding to the read optical output level detected by the optical output level control unit, thereby calculating the indicating value of the D/A converter.

The optical output level control unit may control mutually different amplifier units employing a D/A converter to amplify the common output of the D/A converter, thereby calculating the indicating value corresponding to the erase optical output level, and the indicating value corresponding to the peak optical output level; with the calibration unit controlling the optical output level control unit to detect each indicating value when setting the gain of the amplifier unit to a predetermined value, and controlling the emission unit to emit and output the laser beam with a plurality of mutually different optical output levels, at each of the channel for controlling the erase optical output level, and the channel for controlling the peak optical output level.

The calibration unit may control the emission unit to emit and output the laser beam with the same plurality of optical output levels as those last time while setting the gain of the amplifier unit to a value equivalent to each detected indicating value, thereby performing calibration processing again.

The calibration unit may detect the indicating value corresponding to the erase optical output level in a state in which the gain of the amplifier unit is set to the maximum at a channel for controlling the erase optical output level, and set a value equivalent to the detected indicating value corresponding to the erase optical output level to the gain of the amplifier unit as the predetermined value.

The calibration unit may perform the calibration processing while the emission unit performs reading processing or writing processing of the information as to the optical disc to calibrate the indicating value corresponding to the erase optical output level, and the indicating value corresponding to the peak optical output level, of the optical output level control unit.

The optical output level control unit may control mutually different amplifier units employing a D/A converter to amplify the common output of the D/A converter, thereby calculating the indicating value corresponding to the erase optical output level, and the indicating value corresponding to the peak optical output level; with the calibration unit controlling the emission unit to emit and output the laser beam with the same plurality of optical output levels those in the previous calibration processing, while controlling the optical output level control unit to set the gain of the amplifier unit to a value equivalent to each indicating value detected at the previous calibration processing, at each of the channel for controlling the erase optical output level and the channel for controlling the peak optical output level, thereby performing calibration processing.

The calibration unit may detect the indicating values when controlling the emission unit to irradiate the laser beam on a predetermined area of the optical disc with a first optical output level, await while the optical disc rotates once, detect the indicating values when controlling the emission unit to irradiate the laser beam with a second optical output level, and adjust each of the indicating values corresponding to the peak optical output level and the erase optical output level from the relation between each detected indicating value and the optical output level, as the calibration processing.

The calibration unit may control the optical output level control unit to detect the indicating values a plurality of times, thereby setting the average value of a plurality of detected values excluding the maximum value and minimum value as a detected indicating value.

According to an embodiment of the present invention, an information processing method for an information processing device for performing calibration of an optical output level control unit for controlling the optical output level of a laser beam which an emission unit emits and outputs by a plurality of channels controlling the current value of current supplied to the emission unit for emitting and outputting a laser beam with an optical output level according to the current value of the supplied current, includes, for each channel regarding a part or all of the plurality of channels of the optical output control unit the steps of: controlling the emission unit to emit and output the laser beam with a plurality of mutually different optical output levels; controlling the optical output level control unit to detect the indicating value of the current value corresponding to each optical output level; obtaining the relation between the indicating value and the optical output level; and adjusting the indicating value corresponding to a target optical output level in accordance with the relation.

According to an embodiment of the present invention, a program causes a computer, which performs calibration of an optical output level control unit for controlling the optical output level of a laser beam which an emission unit emits and outputs by a plurality of channels controlling the current value of current supplied to the emission unit for emitting and outputting a laser beam with an optical output level according to the current value of the supplied current, to execute information processing including, for each channel regarding a part or all of the plurality of channels of the optical output control unit, the steps of: controlling the emission unit to emit and output the laser beam with a plurality of mutually different optical output levels; controlling the optical output level control unit to detect the indicating value of the current value corresponding to each optical output level; obtaining the relation between the indicating value and the optical output level; and adjusting the indicating value corresponding to a target optical output level in accordance with the relation.

According to an embodiment of the present invention, with regard to a part or all of multiple channels of an optical output level control unit, for each channel, an emission unit emits and outputs a laser beam with mutually different multiple optical output levels, and an optical output level control unit detects the indicating value of a current value corresponding to each optical output level to obtain the relation between the indicating value and optical output level, and adjusts the indicating value corresponding to a target optical output level in accordance with the relation thereof.

According to the present invention, control of the emission output level of a laser beam can be calibrated, and particularly can be calibrated so as to perform control of the emission output level of the laser beam in a more precise manner.

### BRIEF DESCRIPTION OF THE DRAWINGS

FIG. 1 is a block diagram illustrating a principal configuration example of an optical disc drive to which an embodiment of the present invention has been applied;

FIG. 2 is a diagram for describing a detailed configuration example of an optical head unit in FIG. 1;

FIG. 3 is a block diagram for describing a detailed configuration example of a successive comparison A/D converter;

FIG. 4 is a functional block diagram illustrating functions relating to calibration processing which a CPU has;

FIG. 5 is a diagram for describing a situation of current buildup;

FIG. 6 is a diagram for describing operation of the configuration example shown in FIG. 2;

FIG. 7 is a diagram for describing operation of the configuration example shown in FIG. 2;

FIG. 8 is a flowchart for describing a flow example of initial calibration processing;

FIG. 9 is a schematic view for describing a flow example of initial calibration processing;

FIG. 10 is a flowchart for describing a flow example of control voltage input processing at the time of read operation;

FIG. 11 is a diagram illustrating a situation example of the operation of an optical head unit at the time of execution of the control voltage input processing at the time of read operation;

FIG. 12 is a flowchart for describing a flow example of cool-channel two-point calibration processing;

FIG. 13 is a diagram illustrating a situation example of the operation of the optical head unit at the time of execution of the cool-channel two-point calibration processing;

FIG. 14 is a schematic view illustrating a situation of the control voltage input processing at the time of read operation and cool-channel two-point calibration processing, of the initial calibration processing;

FIG. 15 is a graph illustrating the relation between a target value and P1INTMON;

FIG. 16 is a flowchart for describing a flow example of full-scale evaluation processing;

FIG. 17 is a diagram illustrating a situation example of the operation at the time of execution of the full-scale evaluation processing as to an erase channel, of respective units of the optical head unit;

FIG. 18 is a diagram illustrating a situation example of the operation at the time of execution of the full-scale evaluation processing as to a peak channel, of the respective units of the optical head unit;

FIG. 19 is a flowchart for describing a flow example of erase-channel two-point calibration phase-1 processing;

FIG. 20 is a schematic view illustrating a substituting example;

FIG. 21 is a flowchart for describing a flow example of peak-channel two-point calibration phase-1 processing;

FIG. 22 is a flowchart for describing a flow example of erase-channel two-point calibration phase-2 processing;

FIG. 23 is a flowchart for describing a flow example of peak-channel two-point calibration phase-2 processing;

FIG. 24 is a diagram for describing a calculation method of ERATIO@WR;

FIG. 25 is a graph illustrating the relation between a target value and EINTMON;

FIG. 26 is a diagram for describing a calculation method of PRATIO@WR;

FIG. 27 is a flowchart for describing a flow example of calibration processing at the time of operation;

FIG. 28 is a schematic view for describing a flow example of the calibration processing at the time of operation;

FIG. 29 is a flowchart for describing a flow example of the control voltage input processing at the time of read operation;

FIG. 30 is a schematic view illustrating a situation example of the control voltage input processing at the time of read operation;

FIG. 31 is a diagram for describing the details of the content of the control voltage input processing at the time of read operation;

FIG. 32 is a flowchart for describing a flow example of PL calibration processing;

FIG. 33 is a schematic view illustrating a situation example of the PL calibration processing;

FIG. 34 is a diagram for describing the details of the content of the PL calibration processing;

FIG. 35 is a flowchart for describing a flow example of the PL calibration processing;

FIG. 36 is a schematic view illustrating a situation example of PH calibration processing;

FIG. 37 is a diagram for describing the details of the content of the PH calibration processing; and

FIG. 38 is a block diagram illustrating a configuration example of a personal computer to which an embodiment of the present invention has been applied.

### DESCRIPTION OF THE PREFERRED EMBODIMENTS

Before describing an embodiment of the present invention, the correspondence between the features of the claims and the specific elements disclosed in an embodiment of the present invention, with or without reference to drawings, is discussed below. This description is intended to assure that an embodiment supporting the claimed invention is described in this specification. Thus, even if an element in the following embodiment is not described as relating to a certain feature of the present invention, that does not necessarily mean that the element does not relate to that feature of the claims. Conversely, even if an element is described herein as relating to a certain feature of the claims, that does not necessarily mean that the element does not relate to the other features of the claims.

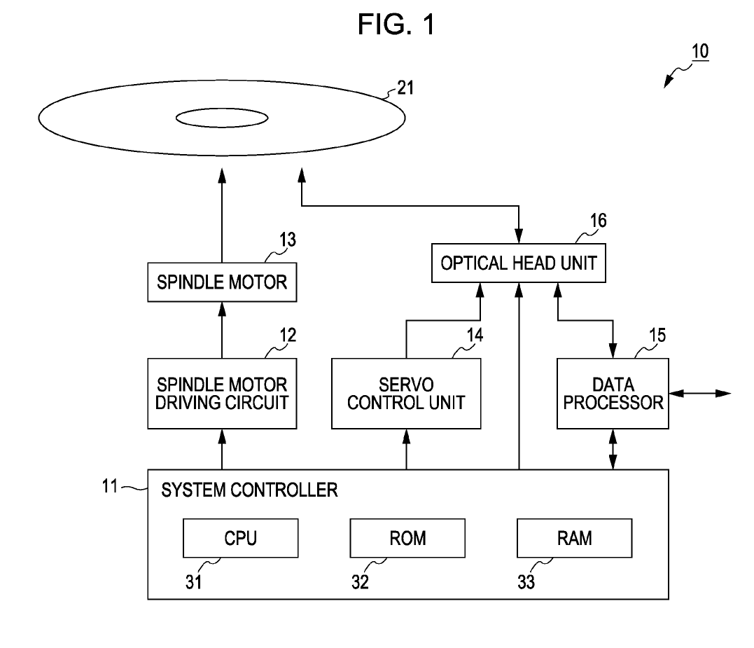

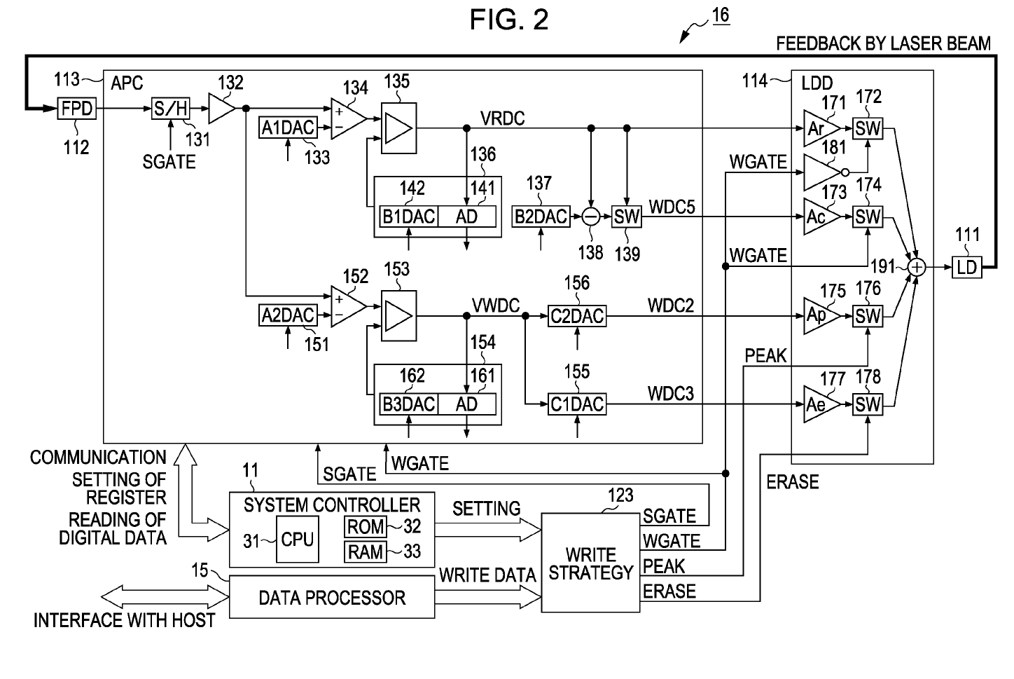

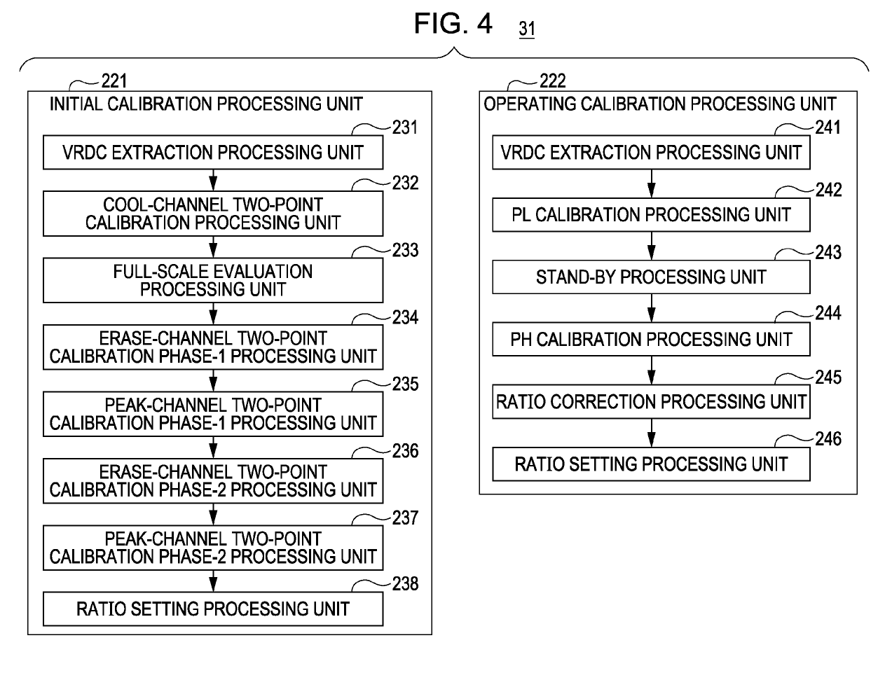

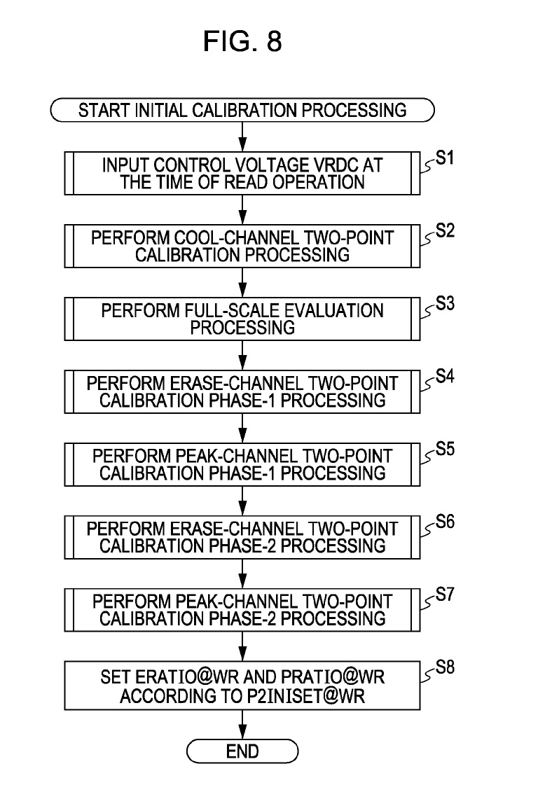

According to an embodiment of the present invention, an information processing device (e.g., system controller 11 in FIG. 1) for performing calibration of an optical output level control unit (e.g., APC 113 in FIG. 2) for controlling the optical output level of a laser beam which an emission unit (e.g., LD 111 in FIG. 2) emits and outputs by a plurality of channels controlling the current value of current supplied to the emission unit for emitting and outputting a laser beam with an optical output level according to the current value of the supplied current, includes a calibration unit (e.g., initial calibration processing unit 221 or operating calibration processing unit 222 in FIG. 4) configured to perform calibration processing (e.g., steps S4 through S7 in FIG. 8) for each channel regarding a part or all of the plurality of channels of the optical output level control unit wherein the emission unit is controlled to emit and output the laser beam with a plurality of different optical output levels, the optical output level control unit is controlled to detect the indicating value of the current value corresponding to each optical output level, the relation between the indicating value and the optical output level is obtained, and an indicating value corresponding to a target optical output level is adjusted in accordance with the relation.

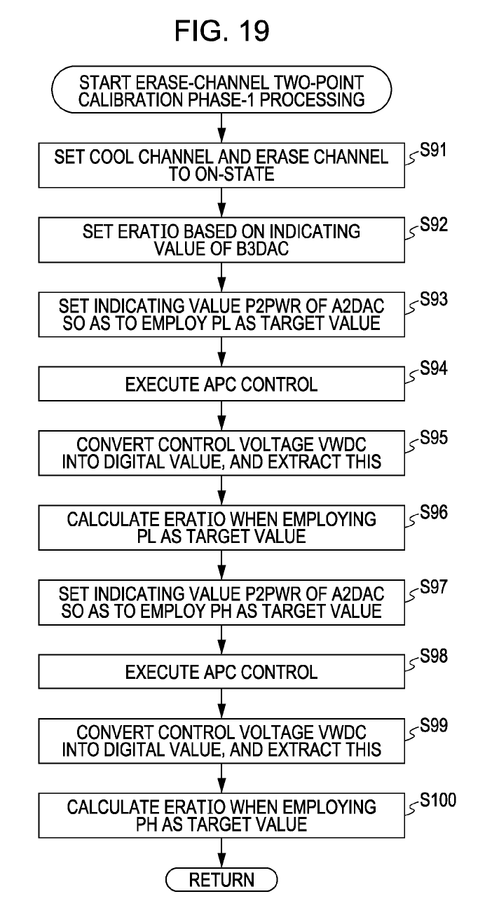

Also, according to an embodiment of the present invention, an information processing method for an information processing device (e.g., system controller 11 in FIG. 1) for performing calibration of an optical output level control unit (e.g., APC 113 in FIG. 2) for controlling the optical output level of a laser beam which an emission unit (e.g., LD 111 in FIG. 2) emits and outputs by a plurality of channels controlling the current value of current supplied to the emission unit for emitting and outputting a laser beam with an optical output level according to the current value of the supplied current, includes for each channel regarding a part or all of the plurality of channels of the optical output control unit the steps of: controlling the emission unit to emit and output the laser beam with a plurality of mutually different optical output levels (e.g., steps S93 and S97 in FIG. 19); controlling the optical output level control unit to detect the indicating value of the current value corresponding to each optical output level (e.g., steps S95 and S99 in FIG. 19); obtaining the relation between the indicating value and the optical output level (e.g., steps S96 and S100 in FIG. 19); and adjusting the indicating value corresponding to a target optical output level in accordance with the relation (e.g., step S8 in FIG. 8).

Further, according to an embodiment of the present invention, a program causes a computer (e.g., system controller 11 in FIG. 1), which performs calibration of an optical output level control unit (e.g., APC 113 in FIG. 2) for controlling the optical output level of a laser beam which an emission unit (e.g., LD 111 in FIG. 2) emits and outputs by a plurality of channels controlling the current value of current supplied to the emission unit for emitting and outputting a laser beam with an optical output level according to the current value of the supplied current, to execute information processing including, for each channel regarding a part or all of the plurality of channels of the optical output control unit, the steps of: controlling the emission unit to emit and output the laser beam with a plurality of mutually different optical output levels (e.g., steps S93 and S97 in FIG. 19); controlling the optical output level control unit to detect the indicating value of the current value corresponding to each optical output level (e.g., steps S95 and S99 in FIG. 19); obtaining the relation between the indicating value and the optical output level (e.g., steps S96 and S100 in FIG. 19); and adjusting the indicating value corresponding to a target optical output level in accordance with the relation (e.g., step S8 in FIG. 8).

An embodiment of the present invention will now be described. FIG. 1 is a block diagram illustrating a principal configuration example of an optical disc drive to which an embodiment of the present invention has been applied.

An optical disc drive 10 shown in FIG. 1 is a device for performing reading or writing of information as to an optical disc 21 mounted on a predetermined position. The optical disc drive 10 includes a system controller 11, spindle motor driving circuit 12, spindle motor 13, servo control unit 14, data processor 15, and optical head unit 16.

The system controller 11 is a control unit for controlling operation of each unit within the optical disc drive 10. A CPU (Central Processing Unit) 31 of the system controller 11 executes various types of processing in accordance with a program stored in ROM (Read Only Memory) 32, or a program loaded in RAM (Random Access Memory) 33. Data used for various types of processing which the CPU 31 executes, and so forth are also stored in the RAM 33 as appropriate.

The spindle motor driving circuit 12, which is controlled by the system controller 11, controls rotational driving of the spindle motor 13 for rotating the optical disc 21. The servo control unit 14, which is controlled by the system controller 11, performs the position control of an optical pickup (optical head unit 16). The data processor 15, which is controlled by the system controller 11, performs information processing with information read out from the optical disc 21 and information to be written in the optical disc 21 as a processing target. The optical head unit 16, which is controlled by the system controller 11, irradiates a laser beam on the optical disc 21, and reads out or writes in information. The optical head unit 16, which is controlled by the system controller 11, irradiates a laser beam to the optical disc 21, and reads out or writes in information.

For example, the optical head unit 16 converts digital data obtained from the data processor 15 from an electric signal to an optical signal (laser beam), irradiates this on the optical disc 21 while switching the optical output level of the laser beam thereof to one of cool power (cool optical output level) which is emission power when cooling the optical disc surface, erase power (erase optical output level) which is emission power when erasing information recorded in the optical disc, and peak power (peak optical output level) which is emission power when writing information in the optical disc, thereby writing the digital data thereof in the optical disc 21. Also, the optical head unit 16 irradiates a laser beam on the optical disc 21 with read power (read optical output level) which is emission power when reading out information recorded in the optical disc, thereby extracting digital data recorded in the optical disc 21 as an optical signal, and converting this into an electric signal to supply this to the data processor 15.

With such an optical disc drive 10, control of laser emission power is, as described later, performed by the optical head unit 16. Calibration of control of the laser emission power thereof is executed by the system controller 11.

FIG. 2 is a diagram for describing a detailed configuration example of the optical head unit 16 in FIG. 1. Note that in FIG. 2, the system controller 11 and data processor 15 are also shown along with the configuration of the optical head unit 16 for the sake of facilitating description. In FIG. 2, the optical head unit 16 includes an LD (Laser Diode) 111, FPD (Front Photo Detector) 112, APC (Auto Power Control) 113, LDD (Laser Diode Driver) 114, and write strategy 123.

The LD 111 is a laser diode for irradiating a laser beam for reading out or writing in information on the optical disc 21 in FIG. 1. The LD 111 emits and outputs a laser beam with power corresponding to the current value of current supplied from the LDD 114.

The FPD 112 is a photodetector, which is provided near the LD 111, for detecting a laser beam output from the LD 111. The FPD 112 subjects a detected laser beam to photoelectric conversion, and supplies an electric signal indicating the power of the laser beam thereof (optical output level) as voltage to the APC 113.

The APC 113 performs control of the power (optical output level) of a laser beam emitted and output by the LD 111 based on the electric signal supplied from the FPD 112. The APC 113 supplies to the LDD 114 an indicating value (control voltage) indicating the current value of current supplied to the LD 111, thereby controlling the power of the laser beam emitted and output by the LD 111. That is to say, the APC 113 recognizes the power of the laser beam emitted and output by the LD 111 from the voltage of the electric signal supplied from the FPD 112, and corrects the indicating value to be output according to the power thereof. For example, the APC 113 increases the indicating value to be output so as to increase the power of the laser beam in a case wherein the power (the voltage of the electric signal supplied from the FPD 112) of the laser beam is smaller than desired power (target value), and decreases the indicating value to be output so as to decrease the power of the laser beam in a case wherein the power of the laser beam is greater than desired power (target value).

Note that the APC 113 includes multiple channels for controlling the power of a laser beam. The LD 111 not only outputs a laser beam with constant power but also emits a laser beam with power corresponding to a situation such as reading, writing, or the like. The APC 113 performs power control with a different power level at each channel based on the control of the system controller 11 and write strategy 123, thereby realizing the control with these multiple power levels.

With the example shown in FIG. 2, the APC 113 includes a channel for outputting an indicating value for controlling read power (read optical output level) which is emission power when reading out information from the optical disc, a channel for outputting an indicating value for controlling cool power, a channel for outputting an indicating value for controlling erase power, and a channel for outputting an indicating value for controlling peak power.

The LDD 114 converts the indicating value supplied from each channel of the APC 113 into the current of the current value corresponding to the indicating value thereof, and adds the current selected by the write strategy 123 to this, and supplies this to the LD 111.

The write strategy 123 controls the APC 113 and LDD 114 based on the control of the system controller 11, or the write data supplied from the data processor 15, thereby enabling the LD 111 to emit and output a laser beam with desired power. For example, the write strategy 123 supplies a control signal WGATE for switching between reading processing and writing processing to the APC 113 and LDD 114. Also, for example, the write strategy 123 supplies to the LDD 114 a control signal PEAK for controlling each unit so as to emit and output a laser beam with peak power to the LDD 111, and a control signal ERASE for controlling each unit so as to emit and output a laser beam with erase power to the LD 111. Further, the write strategy 123 supplies to the APC 113 a control signal SGATE for instructing to sample/hold the voltage level of the electric signal supplied from the FPD 112.

Next, the details of the APC 113 will be described. A sample/hold unit (S/H) 131 of the APC 113 samples an electric signal supplied from the FPD 112 in accordance with the control signal SGATE supplied from the write strategy 123, and then holds the value thereof constant. The held value is amplified at an amplifier 132 with a predetermined gain, and supplied to comparators 134 and 152.

An A1DAC 133 is a 10-bit D/A (Digital/Analog) converter, and supplies the voltage corresponding to input (digital data) which has been set to the comparator 134. A target value (a digital value equivalent to a target value) of the control voltage VRDC of the read channel for controlling read power (i.e., the indicating value of read power) is set to the input of the A1DAC 133 by the system controller 11. The comparator 134 compares the output of the amplifier 132 which has been input and the output of the A1DAC 133, and supplies the comparison result (difference value) thereof to a control voltage adjustment unit 135.

The control voltage adjustment unit 135 selects one of the output of a B1DAC 142 which is the D/A converter function of a successive comparison A/D (Analog/Digital) converter 136, and the output of the comparator 134, and adjusts the control voltage VRDC of the read channel (i.e., indicating value of read power) based on the selected input. The input of selection is controlled by the write strategy 123. For example, upon the output of the comparator 134 being selected as input, the control voltage adjustment unit 135 reflects the difference value thereof on the output (control voltage VRDC). For example, in a case wherein the difference value is positive (i.e., in a case wherein the power of a laser beam is greater than a target value), the control voltage adjustment unit 135 decreases the control voltage VRDC (the indicating value of read power). Conversely, in a case wherein the difference value is negative (i.e., in a case wherein the power of a laser beam is smaller than a target value), the control voltage adjustment unit 135 increases the control voltage VRDC (indicating value of read power). Also, in a case wherein the output of the B1DAC 142 is selected as input, the control voltage adjustment unit 135 outputs the output of the B1DAC 142 thereof as is as the control voltage VRDC (indicating value of read power).

The successive comparison A/D converter 136 is an A/D converter employing a voltage comparison method wherein the comparison between the voltage of an input analog signal and the voltage converted from a digital value is successively performed while changing the digital value, thereby obtaining and outputting the digital value corresponding to the voltage of the input analog signal. The details of the successive comparison A/D converter 136 will be described later, but briefly, the successive comparison A/D converter 136 has a function as an A/D converter and a function as a D/A converter. An AD 141 shown in FIG. 2 exhibits the function as an A/D converter, and the B1DAC 142 exhibits the function as an A/D converter. The resolution of the successive comparison A/D converter 136 is 10 bits, and the resolution of the AD 141 and B1DAC 142 is also 10 bits.

The AD 141 converts the output of the control voltage adjustment unit 135, i.e., the voltage value of the control voltage VRDC into digital data. The converted and obtained digital data is read out by the system controller 11. The B1DAC 142 outputs the analog signal of a voltage value equivalent to the digital data set in a register by the system controller 11. The B1DAC 142 provides constant voltage serving as the initial value (reference value) of the control voltage VRDC to operate the read channel or erase channel in the same way as at the time of normal writing processing when calibrating the erase channel for controlling erase power or the peak channel for controlling peak power, which will be described later.

The control voltage VRDC of which the value has been adjusted by the control voltage adjustment unit 135 is supplied to the LDD 114 as the output of the read channel. Also, the control voltage VRDC is also supplied to a subtracter 138 and electronic switch (SW) 139 of the cool channel for controlling cool power.

A B2DAC 137 outputs to the subtracter 138 the analog signal of a voltage value equivalent to the value (digital data) set as the difference value between read power and cool power which has been set to the register by the system controller 11. The B2DAC 137 provides constant voltage for generating control voltage WDC5 of the cool channel from the control voltage VRDC at the time of later-described normal writing processing. Also, the B2DAC 137 also provides constant voltage to operate the cool channel in the same way as at the time of later-described normal writing processing, even at the time of later-described calibration processing of the erase channel or peak channel. Further, the B2DAC 137 also provides constant voltage to operate the cool channel in the same way as at the time of later-described normal writing processing as preparation for the writing processing, even at the time of later-described normal reading processing.

The subtracter 138 subtracts the output of the B2DAC 137 from the output (control voltage VRDC) of the control voltage adjustment unit 135, and supplies the value thereof to the electronic switch (SW) 139. The electronic switch (SW) 139 selects one of the control voltage VRDC and the output of the subtracter 138, and outputs this to the LDD 114 from the cool channel as the control voltage WDC5.

An A2DAC 151 is a 10-bit D/A converter, and supplies the voltage corresponding to the set input (digital data) to the comparator 152. The target value (a digital value equivalent to a target value) of the control voltage VWDC for setting control voltage WDC2 of the peak channel (i.e., indicating value of peak power), and control voltage WDC3 of the erase channel (i.e., indicating value of erase power) is set to the input of the A2DAC 151. The comparator 152 compares the output of the amplifier 132, and the output of the A2DAC 151, which has been input, and supplies the comparison result (difference value) to a control voltage adjustment unit 153.

The control voltage adjustment unit 153 selects one of the output of a B3DAC 162 which is a D/A converter function of a successive comparison A/D converter 154, and the output of the comparator 152, and adjusts the control voltage VWDC based on the selected input thereof. The selection of input is controlled by the write strategy 123. For example, upon selecting the output of the comparator 152 as input, the control voltage adjustment unit 153 reflects the difference value thereof on the output (control voltage VWDC). For example, in a case wherein the difference value is positive (i.e., in a case wherein the power of a laser beam is great), the control voltage adjustment unit 153 reduces peak power and erase power by reducing the control voltage VWDC. Conversely, in a case wherein the difference value is negative (i.e., in a case wherein the power of a laser beam is small), the control voltage adjustment unit 153 increases peak power and erase power by increasing the control voltage VWDC. Also, in the case of selecting the output of the B3DAC 162 as input, the control voltage adjustment unit 153 outputs the output of the B3DAC 162 thereof as is as the control voltage VWDC.

The successive comparison A/D converter 154 is the same A/D converter as the successive comparison A/D converter 136. An AD 161 in FIG. 2 indicates a function as the A/D converter of the successive comparison A/D converter 154, and the B3DAC 162 indicates a function as a D/A converter. The resolution of the successive comparison A/D converter 154 is 10 bits, and the resolution of the AD 161 and B3DAC 162 is also 10 bits.

The AD 161 converts the output of the control voltage adjustment unit 153, i.e., the voltage value of the control voltage VWDC into digital data. The digital data converted and obtained is read out by the system controller 11.

The B3DAC 162 is a D/A converter of 10-bit resolution, and provides constant voltage serving as the initial value (reference value) of the control voltage VWDC for the erase channel and peak channel at the time of later-described normal writing processing. Further, the B3DAC 162 provides constant voltage to operate the erase channel and peak channel in the same way as those at the time of later-described normal writing processing as preparation for the writing processing even at the time of later-described normal reading processing. The B3DAC 162 outputs the analog signal of a voltage value equivalent to the digital data set to the register by the system controller 11.

The control voltage VWDC of which the value is adjusted by the control voltage adjustment unit 153 is further supplied to a CLDAC 155 and C2DAC 156 which are D/A converters for a predetermined coefficient (RATIO) for multiplying input voltage by RATIO. The C1DAC 155 and C2DAC 156 are 8-bit D/A converters, and each attenuates the control voltage VWDC according to the ratio of an input digital value as to a full scale.

The C1DAC 155 is a D/A converter of the erase channel, and the control voltage WDC3 of which the value is adjusted by the C1DAC 155 is supplied to the LDD 114 as the output of the erase channel. Also, the C2DAC 156 is a D/A converter of the peak channel, and the control voltage WDC2 of which the value is adjusted by the C2DAC 156 is supplied to the LDD 114 as the output of the peak channel.

Next, the details of the LDD 114 will be described. With the LDD 114, the control voltage VRDC supplied from the APC 113 is converted into the current of a current value corresponding to the voltage value thereof at an amplifier (Ar) 171, and supplied to an electronic switch (SW) 172. Also, the control voltage WDC5 supplied from the APC 113 is converted into the current of a current value corresponding to the voltage value thereof at an amplifier (Ac) 173, and supplied to an electronic switch (SW) 174. Further, the control voltage WDC2 supplied from the APC 113 is converted into the current of a current value corresponding to the voltage value thereof at an amplifier (Ap) 175, and supplied to an electronic switch (SW) 176. Also, the control voltage WDC3 supplied from the APC 113 is converted into the current of a current value corresponding to the voltage value thereof at an amplifier (Ae) 177, and supplied to an electronic switch (SW) 178.

The control signal WGATE is supplied to the electronic switch (SW) 172 from the write strategy 123 through a NOT circuit (logical negation circuit) as a switching control signal thereof. When the control signal WGATE is OFF, the electronic switch (SW) 172 supplies the output of the amplifier (Ar) 171 to an adder 191. Also, the control signal WGATE is supplied to the electronic switch (SW) 174 from the write strategy 123 as a switching control signal thereof. When the control signal WGATE is ON, the electronic switch (SW) 174 supplies the output of the amplifier (Ac) 173 to the adder 191. That is to say, when readout (read) of information from the optical disc 21 is selected, the electronic switch (SW) 172 goes to an ON state, the electronic switch (SW) 174 goes to an OFF state, and the output of the amplifier (Ar) 171 is supplied to the adder 191. Conversely, when writing (write) of information to the optical disc 21 is selected, the electronic switch (SW) 174 goes to an ON state, the electronic switch (SW) 172 goes to an OFF state, and the output of the amplifier (Ac) 173 is supplied to the adder 191.

The control signal PEAK is supplied to the electronic switch (SW) 176 from the write strategy 123 as a switching control signal thereof. When the control signal PEAK is ON, the electronic switch (SW) 176 supplies the output of the amplifier (Ap) 175 to the adder 191. The control signal ERASE is supplied to the electronic switch (SW) 178 from the write strategy 123 as a switching control signal thereof. When the control signal ERASE is ON, the electronic switch (SW) 178 supplies the output of the amplifier (Ae) 177 to the adder 191.

The adder 191 adds and integrates the current supplied from the electronic switches (SW) 172, 174, 176, and 178 each, and supplies the addition result thereof to the LD 111. The LD 111 outputs a laser beam with power corresponding to the current value of the supplied current.

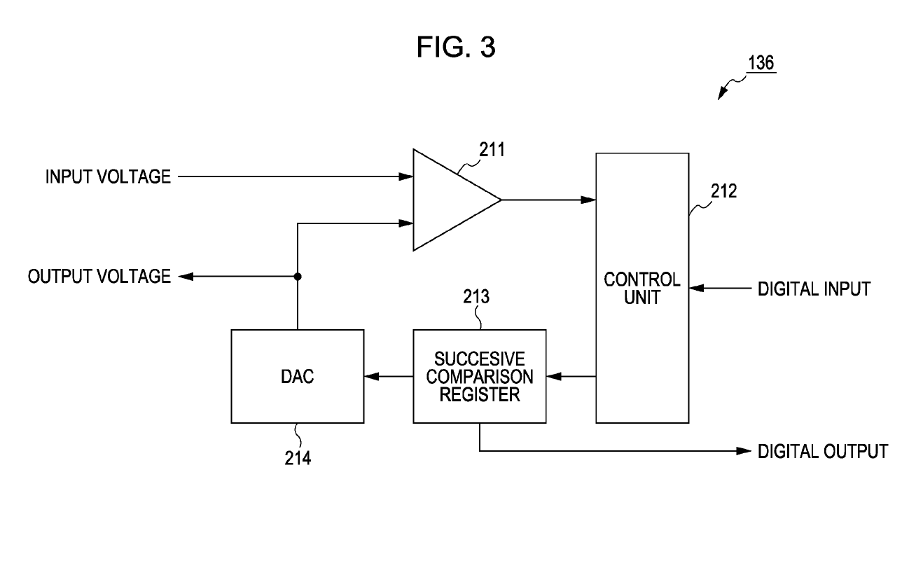

FIG. 3 is a block diagram for describing a detailed configuration example of the successive comparison A/D converter 136. As shown in FIG. 3, the successive comparison A/D converter 136 includes a comparator 211, control unit 212, successive comparison register 213, and DAC (Digital Analog Converter) 214. The successive comparison A/D converter 136 also serves as not only as an A/D converter (AD 141) but also as a D/A converter (B1DAC 142), as described above.

First, description will be made regarding a case wherein the successive comparison A/D converter 136 serves as an A/D converter. The control unit 212 sets a digital value to be compared with input voltage to the successive comparison register 213. The DAC 214 outputs the analog signal of voltage equivalent to the digital value set in the successive comparison register 213. The comparator 211 compares input voltage, and the output voltage of the DAC 214 thereof, and informs the control unit 212 of the difference value thereof as a comparison result. The control unit 212 updates the value set in the successive comparison register 213 according to the difference value thereof. Thus, the output voltage of the DAC 214 is changed. As described above, while repeating such a comparison sequentially, the control unit 212 approximates the digital value to be set in the successive comparison register 213 to input voltage.

For example, the control unit 212 determines the digital value to be set in the successive comparison register 213 in accordance with the comparison result of the comparator 211 one bit at a time in order from MSB (Most Significant Bit) to LSB (Least Significant Bit). That is to say, first, the control unit 212 sets the value of the MSB to “1”, and sets the values of the others to “0”, and controls the comparator 211 to compare input voltage therewith. Subsequently, if input voltage is greater with the comparison result of the comparator 211, the control unit 212 sets the next bit to “1”, and if the output voltage of the DAC 214 is greater, the control unit 212 returns the current bit to “0”, and sets the next bit to “1”, and controls the comparator 211 to perform comparison again. While repeating such a comparison, each bit of the successive comparison register 213 is determined so as to approximate to input voltage.

Ultimately, upon a digital value equivalent to input voltage being set, the control unit 212 controls the successive comparison register 213 to output (digital output) the value set in the successive comparison register 213 to the outside of the successive comparison A/D converter 136.

Next, description will be made regarding a case wherein the successive comparison A/D converter 136 serves as a D/A converter. The control unit 212 sets an input digital value (digital input) in the successive comparison register 213. The DAC 214 outputs the analog signal of voltage equivalent to the digital value set in the successive comparison register 213 to the outside of the successive comparison A/D converter 136.

As described above, the successive comparison A/D converter 136 realizes functions serving as the AD 141 and B1DAC 142. Note that the successive A/D converter 154 basically has the same configuration as the successive comparison A/D converter 136. Accordingly, the description of the successive comparison A/D converter 136 described with reference to FIG. 3 can be applied to the successive comparison A/D converter 154 as well.

The system controller 11 performs calibration processing of an initial value, gain, and so forth which the APC 113 regards as control reference such that the APC 113 can perform power control more precisely with such an APC system.

FIG. 4 is a functional block diagram illustrating functions relating to calibration processing which the CPU 31 of the system controller 11 thereof has. As shown in FIG. 4, the CPU 31 includes an initial calibration processing unit 221 for executing initial calibration processing which is calibration processing performed before reading or writing of information as to the optical disc 21 is performed by the LD 111 after the optical disc 21 is set in a predetermined position of the optical disc drive 10, and an operating calibration processing unit 222 for executing operating calibration processing which is calibration processing performed between the reading processing and writing processing.

The initial calibration processing is calibration processing of which the principal object is absorption of gain errors, offset, and so forth at the time of operation, long-term variation per hour of the circuit of the optical disc drive 10, variation in an external environment, or the like, and the operating calibration processing is calibration processing of which the principal object is absorption of the temperature output properties (output variation due to increase in temperature) of the LD 111, and short-term variation per hour.

Note that the operating calibration processing is performed while focusing on the optical disc 21 in a so-called trace state so as to ensure the instantaneousness (real time nature) of the reading processing and writing processing (so as not to prevent the reading processing and writing processing). Operation for interrupting trace to change the optical disc 21 to an out-of-focus state before the calibration processing, and also operation for focusing on the optical disc 21 after the calibration processing can be omitted by performing the calibration processing in a trace state, whereby the calibration processing can be performed at high speed, and accordingly, the real time nature of the reading processing and writing processing can be ensured.

The initial calibration processing unit 221 includes a VRDC extraction processing unit 231, cool-channel two-point calibration processing unit 232, full-scale evaluation processing unit 233, erase-channel two-point calibration phase-1 processing unit 234, peak-channel two-point calibration phase-1 processing unit 235, erase-channel two-point calibration phase-2 processing unit 236, peak-channel two-point calibration phase-2 processing unit 237, and RATIO setting processing unit 238, which execute the corresponding each process of the initial calibration processing.

The VRDC extraction processing unit 231 extracts the control voltage VRDC at the time of output of read power (at the time of readout operation). This extracted value is employed for other processes. The cool-channel two-point calibration processing unit 232 is a processing unit for performing calibration processing relating to the control voltage WDC5 of the cool channel which is a channel for controlling cool power. More specifically, the cool-channel two-point calibration processing unit 232 obtains the control voltage WDC5 corresponding to two mutually different target values, and calibrates the indicating value of the B2DAC 137 corresponding to the target value at the time of the writing processing based on the relation between the two points thereof.

The full-scale evaluation processing unit 233 determines the value of the B3DAC 162 so as to effectively employ the full scale of the C1DAC 155 or C2DAC 156 which is a DAC for RATIO as much as possible. This value is employed for the calibration processing of the peak channel and erase channel.

The erase-channel two-point calibration phase-1 processing unit 234, and erase-channel two-point calibration phase-2 processing unit 236 are processing units for performing calibration processing relating to the control voltage WDC3 of the erase channel which is a channel for controlling erase power. Also, the peak-channel two-point calibration phase-1 processing unit 235, and peak-channel two-point calibration phase-2 processing unit 237 are processing units for performing calibration processing relating to the control voltage WDC2 of the peak channel which is a channel for controlling peak power. More specifically, the erase-channel two-point calibration phase-1 processing unit 234 and peak-channel two-point calibration phase-1 processing unit 235 obtain the indicating value of the C1DAC 155 and C2DAC 156 corresponding to the two mutually different target values by employing the value of the B3DAC 162 obtained by the full-scale evaluation processing unit 233 (two-point calibration processing phase-1). The erase-channel two-point calibration phase-2 processing unit 236 and peak-channel two-point calibration phase-2 processing unit 237 obtain the indicating values of the C1DAC 155 and C2DAC 156 again by employing the indicating values of the C1DAC 155 and C2DAC 156 obtained by the erase-channel two-point calibration phase-1 processing unit 234 and peak-channel two-point calibration phase-1 processing unit 235 (two-point calibration processing phase-2).

The RATIO setting processing unit 238 obtains and sets (calibrates) the indicating values of the C1DAC 155 and C2DAC 156 at the time of the writing processing from the relation between the two target values and the indicating values of the C1DAC 155 and C2DAC 156 corresponding thereto obtained by the erase-channel two-point calibration phase-2 processing unit 236 and peak-channel two-point calibration phase-2 processing unit 237.

The operating calibration processing unit 222 includes a VRDC extraction processing unit 241, PL calibration processing unit 242, stand-by processing unit 243, PH calibration processing unit 244, RATIO correction processing unit 245, and RATIO setting processing unit 246, which execute the corresponding each process of the operating calibration processing.

The operating calibration processing is basically processing equivalent to two-point calibration processing phase-2 as to the erase channel and peak channel of the initial calibration processing. Calibration processing as to cool power is omitted since there is no problem even if cool power deteriorates in precision as compared to peak power and erase power. Also, the processing of the phase 1 of the calibration processing as to peak power and erase power is omitted by employing the result of the previous calibration processing.

The VRDC extraction processing unit 241 extracts the control voltage VRDC of the read channel (indicating value of read power) at the time of the reading processing, similar to the VRDC extraction processing unit 231. The PL calibration processing unit 242 obtains the indicating values of the C1DAC 155 and C2DAC 156 regarding PL which is the smaller target value of the above-mentioned two target values. The PH calibration processing unit 244 obtains the indicating values of the C1DAC 155 and C2DAC 156 regarding PH which is the greater target value of the above-mentioned two target values.

The PH calibration processing unit 244 subjects the same RUB (Recording Unit Block) as that of the PL calibration processing unit 242 to processing, so the stand-by processing unit 243 controls the PH calibration processing unit 244 to stand by for start of processing during the optical disc rotating once after the processing by the PL calibration processing unit 242 is completed so as to prevent influence (history effects) of the processing result of the PL calibration processing unit 242 with the processing by the PH calibration processing unit 244.

The RATIO correction processing unit 245 corrects the indicating values (ERATIO and PRATIO) of the C1DAC 155 and C2DAC 156 based on the processing results of the PL calibration processing unit 242 and PH calibration processing unit 244, and the RATIO setting processing unit 246 obtains and sets the indicating values (ERATIO and PRATIO) of the C1DAC 155 and C2DAC 156 at the time of the writing processing from the relation of the indicating values of the C1DAC 155 and C2DAC 156 corresponding to PL and PH.

Next, description will be made regarding the operation of each unit of the above-mentioned optical disc drive 10. First, operation when performing normal reading and writing will be described. In the case of performing reading or writing of information as to the optical disc 21, the LD 111 in FIG. 2 emits and outputs a laser beam. As described above, the LD 111 outputs a laser beam with the power corresponding to the current value of the current supplied from the LDD 114. In other words, the LDD 114 controls the emission output power of the LD 111 by the current value of the current supplied to the LD 111.

The output power of the LD 111 emits and outputs a laser beam with mutually different power according to processing content such as reading of information, erasing of information, writing of information, cooling of the surface of the optical disc 21, or the like. As described above, the LDD 114 builds up (adds) multiple currents, and realizes the emission output of a laser beam with each power of the LD 111 by selecting a combination thereof.

The LD 114 generates the current of the current value corresponding to the indicating value (control voltage), which is supplied from the APC 113 for each channel, for each channel thereof. The write strategy 123 selects current to be built up by a control signal such as WGATE, PEAK, ERASE, or the like.

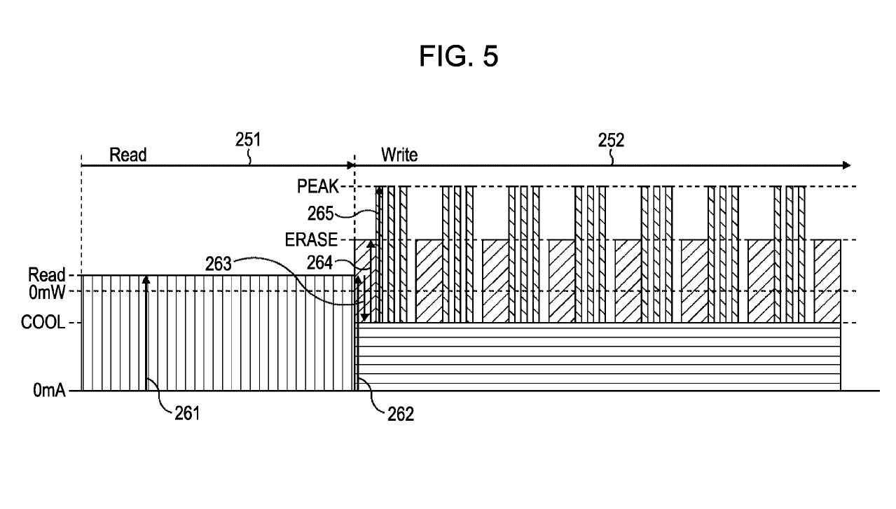

FIG. 5 is a diagram illustrating a waveform example of a laser beam for describing a situation of current buildup thereof. In FIG. 5, a section indicated with an arrow 251 is a section where the reading processing (Read) is performed, and a section indicated with an arrow 252 is a section where the writing processing (Write) is performed.

As shown in the example in FIG. 5, with the reading processing (Read), only current wherein the control voltage VRDC of the read channel has been converted is selected, and supplied to the LD 111. Accordingly, the LD 111 emits and outputs a laser beam with read power. At this time, as shown in an arrow 261, APC is applied with read power (Read), i.e., the control voltage VRDC corresponding to the read power by the APC 113.

Also, at the time of cooling of the surface of the optical disc 21 with the writing processing (Write), only current wherein the control voltage WDC5 of the cool channel has been converted is selected, and supplied to the LD 111. The power of a laser beam emitted and output based on this current, i.e., cool power (power equivalent to the control voltage WDC5) is generated by subtracting power equivalent to the output of the B2DAC 137 (arrow 263) from the read power equivalent to the control voltage VRDC (arrow 262). The value of the B2DAC 137 indicated with the arrow 263 is fixed during the writing processing, so APC is applied with the control voltage VRDC indicated by the arrow 262.

With eliminating (erase) of information recorded in the optical disc 21 of the writing processing, current wherein the control voltage WDC5 of the cool channel has been converted, and current wherein the control voltage WDC3 of the erase channel has been converted are selected, and mutually added and supplied to the LD 111. The power of a laser beam emitted and output based on this current, i.e., erase power is generated, as shown with arrows 262 through 264 in the example in FIG. 5, by adding power (arrow 264) equivalent to the control voltage WDC3 to cool power (arrows 262 and 263). That is to say, the control voltage WDC3 controls the difference between erase power and cool power.

With writing (peak) of information in the optical disc 21 of the writing processing, current wherein the control voltage WDC5 of the cool channel has been converted, and current wherein the control voltage WDC2 of the peak channel has been converted are selected, and mutually added and supplied to the LD 111. The power of a laser beam emitted and output based on this current, i.e., peak power is generated, as shown with arrows 262, 263, and 265 in the example in FIG. 5, by adding power (arrow 265) equivalent to the control voltage WDC2 to cool power (arrows 262 and 263). That is to say, the control voltage WDC2 controls the difference between peak power and cool power.

Thus, with the LDD 114, the emission and output of a laser beam with each power by the LD 111 can be controlled with a combination of currents where control voltage supplied from the multiple channels of the APC 113.

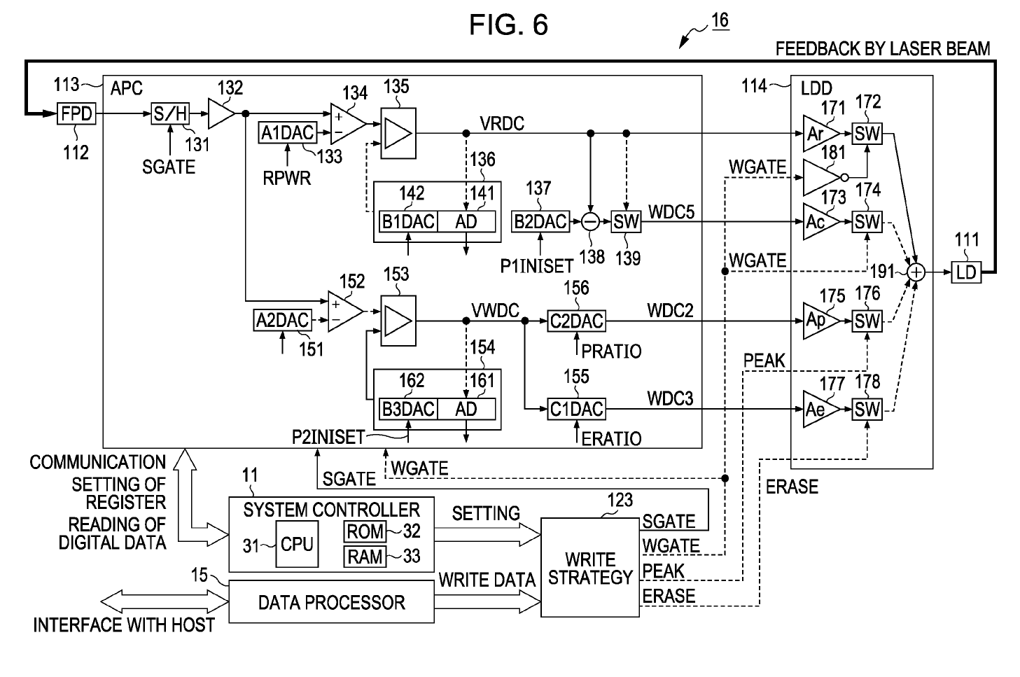

Next, description will be made regarding the operation of each unit within the optical head unit 16 at the time of normal reading processing (at the time of read operation). FIG. 6 is a diagram for describing operation of the configuration example shown in FIG. 2, wherein active electric leads are indicated with solid-line arrows, and inactive electric leads are indicated with dotted-line arrows.

With the reading processing, the write strategy 123 sets all of the values of control signals WGATE, PEAK, and ERASE to OFF. Also, the write strategy 123 sets the control signal SGATE so as to sample/hold voltage at the time of reading.

The voltage value obtained by subjecting the optical output of the LD 111 to photoelectric conversion through the FPD 112 is sampled/held in accordance with the timing of the control signal SGATE supplied from the write strategy 123 by the sample/hold unit (S/H) 131, and the voltage value thereof is amplified at the amplifier 132, and supplied to the comparators 134 and 152.

A predetermined indicating value RPWR is set to the register of the A1DAC 133 as a read power target value. The comparator 134 subtracts voltage equivalent to the indicating value RPWR set to the register, which the A1DAC 133 outputs, from the output of the amplifier 132. Note that no indicating value is set to the register of the B1DAC 142 of the successive comparison A/D converter 136, so the B1DAC 142 does not output analog voltage. Accordingly, the control voltage adjustment unit 135 selects the output of the comparator 134, and controls the voltage value of the control voltage VRDC based on the difference value output by the comparator 134. The control voltage VRDC thereof is converted into current at the amplifier (Ar) 171 of the LDD 114 as the output of the read channel. The converted current is supplied to the electronic switch (SW) 172. The control signal WGATE is OFF, so the electronic switch (SW) 172 supplies the current from the amplifier (Ar) 171 to the adder 191.

Note that at this time, the AD 141 of the successive comparison A/D converter 136 does not perform extraction (digitization) of the control voltage VRDC.

Also, the control voltage VRDC is also supplied to the subtracter 138. A predetermined indicating value P1INISET is set to the register of the B2DAC 137. The subtracter 138 subtracts voltage equivalent to the indicating value P1INISET set to the register, which the B2DAC 137 outputs, from the control voltage VRDC. The electronic switch (SW) 139 selects the output of the subtracter 138, and supplies this to the amplifier (Ac) 173 of the LDD 114 as the output (control voltage WDC5) of the cool channel. The control voltage WDC5 is converted into current at the amplifier (Ac) 173 of the LDD 114. The converted current is supplied to the electronic switch (SW) 174. However, the control signal WGATE is OFF, so the electronic switch (SW) 174 does not supply the current from the amplifier (Ac) 173 to the adder 191.

With the reading processing, no indicating value is set to the register of the A2DAC 151. Accordingly, the comparator 134 does not output comparison results. However, an indicating value P2INISET for controlling erase power and peak power is set to the register of the B3DAC 162 of the successive comparison A/D converter 154. The B3DAC 162 applies voltage equivalent to the P2INISET thereof to the input of the control voltage adjustment unit 153. The control voltage adjustment unit 153 selects the output of the B3DAC 162 thereof to supply this to the C1DAC 155 and C2DAC 156 as the control voltage VWDC.

Note that at this time, the AD 161 of the successive comparison A/D converter 154 does not perform extraction (digitization) of the control voltage VWDC.

The C1DAC 155 attenuates the control voltage VRDC with a ratio equivalent to the indicating value ERATIO set to the register to supply this to the amplifier (Ae) 177 of the LDD 114 as the output (control voltage WDC3) of the erase channel. The control voltage WDC3 is converted into current at the amplifier (Ae) 177 of the LDD 114. The converted current is supplied to the electronic switch (SW) 178. However, the control signal ERASE is OFF, so the electronic switch (SW) 178 does not supply the current from the amplifier (Ae) 177 to the adder 191.

The C2DAC 156 attenuates the control voltage VRDC with a ratio equivalent to the indicating value PRATIO set to the register to supply this to the amplifier (Ap) 175 of the LDD 114 as the output (control voltage WDC2) of the peak channel. The control voltage WDC2 is converted into current at the amplifier (Ap) 175 of the LDD 114. The converted current is supplied to the electronic switch (SW) 176. However, the control signal PEAK is OFF, so the electronic switch (SW) 176 does not supply the current from the amplifier (Ap) 175 to the adder 191.

As described above, with normal reading processing, only the current of the read channel is supplied to the adder 191. Accordingly, the adder 191 supplies the current thereof as is to the LD 111. Thus, the LD 111 emits and outputs a laser beam with read power equivalent to the control voltage VRDC.

Note that description has been made so far wherein the control voltage WDC5 of the cool channel, the control voltage WDC2 of the peak channel, and the control voltage WDC3 of the erase channel are also output to the LDD 114 at the time of the reading processing, but such control voltage is not employed at the time of the reading processing, so the APC 113 may not output such control voltage. However, as described above, each control voltage is allowed to be output, whereby the LDD 114 can immediately supply current equivalent to each control voltage to the LD 111 without providing time lag such as a leading edge or the like, when making the transition to the writing processing from the reading processing.

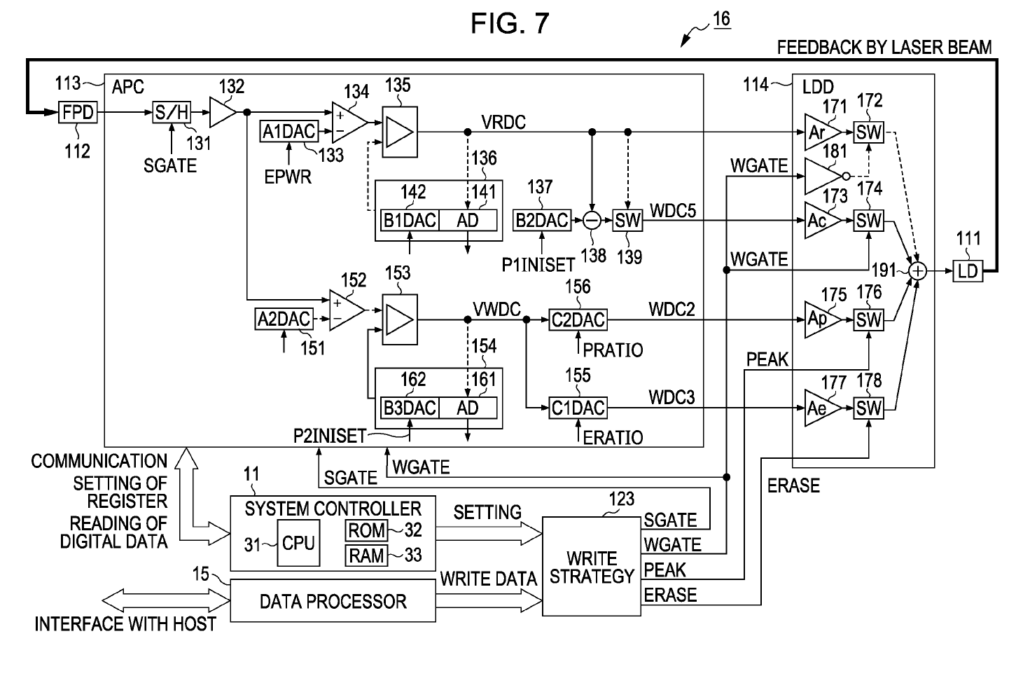

Next, description will be made regarding the operation of each unit within the optical head unit 16 at the time of normal writing processing with reference to FIG. 7. FIG. 7, like FIG. 6, is a diagram for describing operation of the configuration example shown in FIG. 2, wherein active electric leads are indicated with solid-line arrows, and inactive electric leads are indicated with dotted-line arrows.

With normal writing processing, the write strategy 123 sets all of the values of control signals WGATE, PEAK, and ERASE to ON. Strictly, the control signal PEAK is set to ON only when performing writing to the optical disc 21, and the control signal ERASE is set to ON only when performing elimination of information recorded in the optical disc 21. That is to say, these control signals are switched to ON/OFF during the writing processing. Also, the write strategy 123 sets the control signal SGATE so as to sample/hold voltage at the time of erase processing.

The voltage value obtained by subjecting the optical output of the LD 111 to photoelectric conversion through the FPD 112 is sampled/held in accordance with the timing of the control signal SGATE supplied from the write strategy 123 by the sample/hold unit (S/H) 131, and the voltage value thereof is amplified at the amplifier 132, and supplied to the comparators 134 and 152.

A predetermined indicating value EPWR is set to the register of the A1DAC 133 as an erase power target value. The comparator 134 subtracts voltage equivalent to the indicating value EPWR set to the register, which the A1DAC 133 outputs, from the output of the amplifier 132. Note that no indicating value is set to the register of the B1DAC 142 of the successive comparison A/D converter 136, so the B1DAC 142 does not output analog voltage. Accordingly, the control voltage adjustment unit 135 selects the output of the comparator 134, and controls the voltage value of the control voltage VRDC based on the difference value output by the comparator 134. The control voltage VRDC thereof is converted into current at the amplifier (Ar) 171 of the LDD 114 as the output of the read channel. The converted current is supplied to the electronic switch (SW) 172. The control signal WGATE is ON, so the electronic switch (SW) 172 does not supply the current from the amplifier (Ar) 171 to the adder 191.

Note that at this time, the AD 141 of the successive comparison A/D converter 136 does not perform extraction (digitization) of the control voltage VRDC.

Also, the control voltage VRDC is also supplied to the subtracter 138. A predetermined indicating value P1INISET is set to the register of the B2DAC 137. The subtracter 138 subtracts voltage equivalent to the indicating value P1INISET set to the register, which the B2DAC 137 outputs, from the control voltage VRDC. The electronic switch (SW) 139 selects the output of the subtracter 138, and supplies this to the amplifier (Ac) 173 of the LDD 114 as the output (control voltage WDC5) of the cool channel. The control voltage WDC5 is converted into current at the amplifier (Ac) 173 of the LDD 114. The converted current is supplied to the electronic switch (SW) 174. The control signal WGATE is ON, so the electronic switch (SW) 174 supplies the current from the amplifier (Ac) 173 to the adder 191.

With normal writing processing, no indicating value is set to the register of the A2DAC 151. Accordingly, the comparator 134 does not output comparison results. However, an indicating value P2INISET for controlling erase power and peak power is set to the register of the B3DAC 162 of the successive comparison A/D converter 154. The B3DAC 162 applies voltage equivalent to the P2INISET thereof to the input of the control voltage adjustment unit 153. The control voltage adjustment unit 153 selects the output of the B3DAC 162 thereof to supply this to the C1DAC 155 and C2DAC 156 as the control voltage VWDC.

Note that at this time, the AD 161 of the successive comparison A/D converter 154 does not perform extraction (digitization) of the control voltage VWDC.

The C1DAC 155 attenuates the control voltage VRDC with a ratio equivalent to the indicating value ERATIO set to the register to supply this to the amplifier (Ae) 177 of the LDD 114 as the output (control voltage WDC3) of the erase channel. The control voltage WDC3 is converted into current at the amplifier (Ae) 177 of the LDD 114. The converted current is supplied to the electronic switch (SW) 178. When the control signal ERASE is ON, the electronic switch (SW) 178 supplies the current from the amplifier (Ae) 177 to the adder 191.

The C2DAC 156 attenuates the control voltage VRDC with a ratio equivalent to the indicating value PRATIO set to the register to supply this to the amplifier (Ap) 175 of the LDD 114 as the output (control voltage WDC2) of the peak channel. The control voltage WDC2 is converted into current at the amplifier (Ap) 175 of the LDD 114. The converted current is supplied to the electronic switch (SW) 176. When the control signal PEAK is ON, the electronic switch (SW) 176 supplies the current from the amplifier (Ap) 175 to the adder 191.

As described above, with normal writing processing, the current of the cool channel is supplied to the adder 191, and also the current of the erase channel or peak channel is supplied to the adder 191 as appropriate. Accordingly, the adder 191 adds the currents supplied simultaneously to supply this result to the LD 111. Thus, the LD 111 emits and outputs a laser beam with each power as appropriate.

Note that description has been made so far wherein the control voltage VRDC of the read channel is also output to the LDD 114 at the time of normal writing processing, but the control voltage VRDC is not employed at the time of normal writing processing, so the APC 113 may not output this control voltage VRDC. However, as described above, the control voltage VRDC is allowed to be output, whereby the LDD 114 can immediately supply current equivalent to the control voltage VRDC to the LD 111 without providing time lag such as a leading edge or the like, when making the transition to the writing processing from the reading processing.

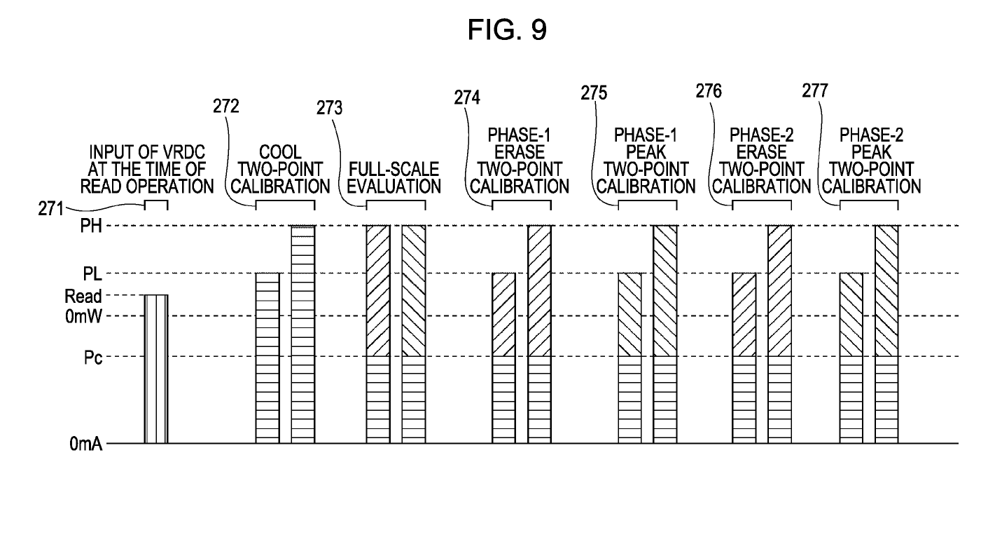

The CPU 31 of the system controller 11 subjects such an APC system to calibration processing. The calibration processing thereof will be described below. First, description will be made regarding the flow of the initial calibration processing with reference to the flowchart in FIG. 8. Description will be made with reference to FIG. 9 as appropriate.

Upon the initial calibration processing being started, in step S1, as shown in a range 271 in FIG. 9, the VRDC extraction processing unit 231 of the initial calibration processing unit 221 executes control voltage input processing at the time of read operation for inputting the control voltage VRDC corresponding to read power at the time of read operation by the AD 141 as a digital value, and inputs the control voltage VRDC at the time of read operation.

In step S2, as shown in a range 272 in FIG. 9, the cool-channel two-point calibration processing unit 232 performs cool-channel two-point calibration processing for obtaining the indicating value of the B2DAC 137 at the time of the writing processing by employing two target values.

In step S3, as shown in a range 273 in FIG. 9, the full-scale evaluation processing unit 233 performs full-scale evaluation processing for setting the indicating value of the B3DAC 162 so as to utilize the full scales of the C1DAC 155 and C2DAC 156 for determining a RATIO in a more effective manner.

In step S4, as shown in a range 274 in FIG. 9, the erase-channel two-point calibration phase-1 processing unit 234 performs erase-channel two-point calibration phase-1 processing (first calibration processing) for obtaining the indicating value of the C1DAC 155 at the time of the writing processing by employing two target values. In step S5, as shown in a range 275 in FIG. 9, the peak-channel two-point calibration phase-1 processing unit 235 performs peak-channel two-point calibration phase-1 processing (first calibration processing) for obtaining the indicating value of the C2DAC 156 at the time of the writing processing by employing two target values.

In step S6, in order to improve the precision of the calibration processing, as shown in a range 276 in FIG. 9, the erase-channel two-point calibration phase-2 processing unit 236 performs second erase-channel two-point calibration processing (erase-channel two-point calibration phase-2). In step S7, in order to improve the precision of the calibration processing, as shown in a range 277 in FIG. 9, the peak-channel two-point calibration phase-2 processing unit 237 performs second peak-channel two-point calibration processing (peak-channel two-point calibration phase-2).

In step S8, the RATIO setting processing unit 238 sets a value ERATIO@WR to be set to the register of the C1DAC 155 at the time of the writing processing, and a value PRATIO@WR to be set to the register of the C2DAC 156 at the time of the writing processing according to a value P2INISET@WR to be set to the register of the B3DAC 162 at the time of the writing processing, which have been set by the above-mentioned processing. Upon the processing in step S8 being completed, the initial calibration processing is ended.

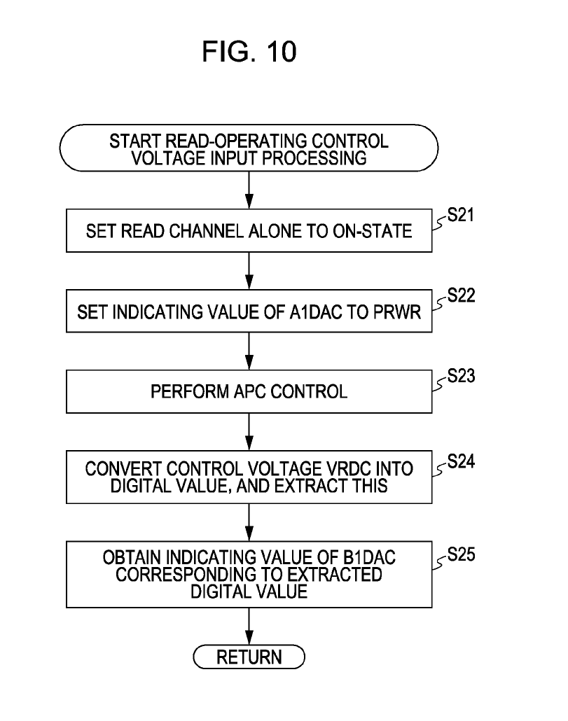

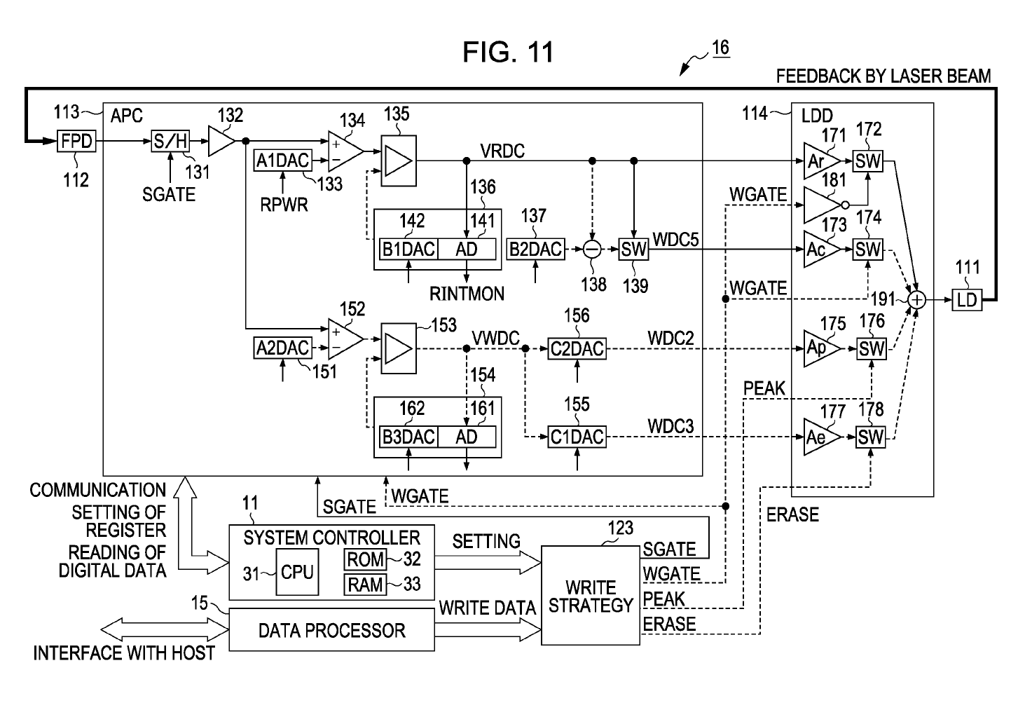

Next, description will be made regarding the details of the processing in steps S1 trough S7. First, a flow example of the control voltage input processing at the time of read operation executed in step S1 will be described with reference to the flowchart in FIG. 10. Description will be made with reference to FIG. 11 as appropriate. FIG. 11 is a diagram illustrating a situation example of the operation at the time of execution of the control voltage input processing at the time of read operation, of each unit of the optical head unit 16 described with reference to FIG. 2.

Upon the control voltage input processing at the time of read operation being started, in step S21 the VRDC extraction processing unit 231 controls the write strategy 123 to set only the read channel to ON. As shown in FIG. 11, the write strategy 123 set all of the control signals WGATE, PEAK, and ERASE to OFF (dotted lines) based on a request from the VRDC extraction processing unit 231. Upon the WGATE being set to OFF, a NOT circuit 181 supplies a control signal in an ON state to the electronic switch (SW) 172. That is to say, only the read channel is set to an ON state. Thus, each unit of the optical head unit 16 basically performs operation at the time of the reading processing.

In step S22, the VRDC extraction processing unit 231 sets the indicating value of the A1DAC 133 to read power RPWR as a target of APC, and in step S23 controls each unit to perform APC control. The comparator 134 compares the output voltage of the amplifier 132, and voltage equivalent to the RPWR output from the A1DAC 133, and supplies the difference value thereof to the control voltage adjustment unit 135. The control voltage adjustment unit 135 selects the difference value of the comparator 134 as input, and adjusts the control voltage VRDC according to the value thereof.

In step S24, the VRDC extraction processing unit 231 controls the AD 141 to convert the control voltage VRDC into a digital value RINTMON, and extracts this. Upon obtaining the RINTMON, in step S25 the VRDC extraction processing unit 231 obtains the indicating value of the B1DAC 142 corresponding to the extracted digital value RINTMON. Upon obtaining the indicating value of the B1DAC 142, the VRDC extraction processing unit 231 ends the control voltage input processing at the time of read operation, returns the processing to step S1 in FIG. 8, and executes the processing in step S2 and thereafter.

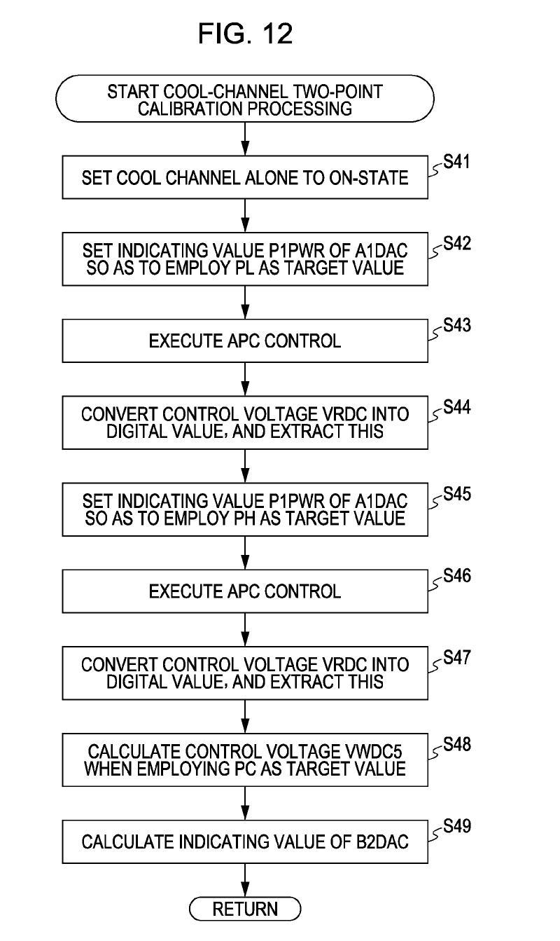

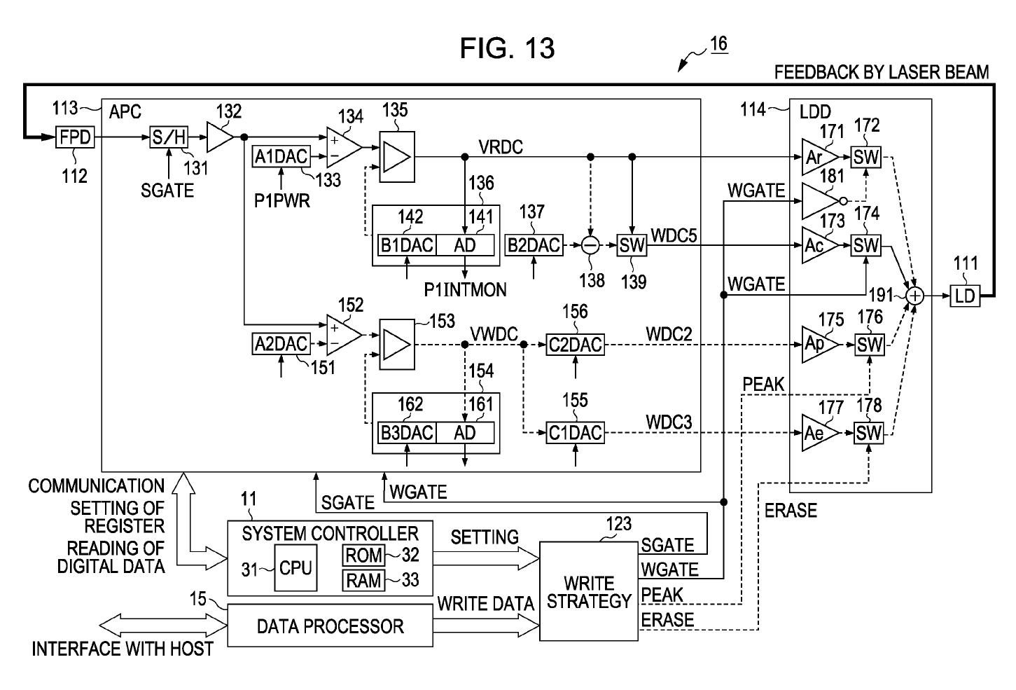

Next, a flow example of the cool-channel two-point calibration processing executed in step S2 in FIG. 8 will be described with reference to the flowchart in FIG. 12. Description will be made with reference to FIG. 13 as appropriate. FIG. 13 is a diagram illustrating a situation example of the operation at the time of execution of the cool-channel two-point calibration processing, of each unit of the optical head unit 16 described with reference to FIG. 2.

The cool-channel two-point calibration processing unit 232 calibrates the control of cool power at the time of the writing processing. That is to say, the cool-channel two-point calibration processing unit 232 performs the calibration of the indicating value of the B2DAC 137 for controlling the difference value of read power and cool power, as described with reference to FIGS. 5 and 7. In the same way as at the time of the writing processing, the cool-channel two-point calibration processing unit 232 performs APC control by employing mutually different predetermined target values PL and PH while controlling the LD 111 to perform laser emission with cool power, and obtains the indicating value of the B2DAC 137 at the time of the writing processing from the control voltage VRDC corresponding to each target value (two-point calibration).

The PL and PH are target values for two-point calibration, of predetermined values. The smaller target value is the PL, and the greater target value is the PH. Arbitrary values can be set as the values of the PL and PH as long as the values are in a range wherein the optical disc drive 10 operates normally (a range wherein failure of the LD 111, destruction of the optical disc 21, or the like does not occur).

Upon the cool-channel two-point calibration processing being started, in step S41 the cool-channel two-point calibration processing unit 232 controls the write strategy 123 to set only the cool channel to ON. As shown in FIG. 13, the write strategy 123 sets the control signal WGATE to ON (solid line), and sets the PEAK and ERASE to OFF (dotted lines) based on a request from the cool-channel two-point calibration processing unit 232. Upon the WGATE being set to ON, the read channel goes to an OFF state, and the cool channel goes to an ON state. The control signals PEAK and ERASE are OFF, so the peak channel and erase channel become OFF. That is to say, only the cool channel goes to an ON state. Thus, each unit of the optical head unit 16 performs the same operation as at the time of emitting a laser beam with cool power with the writing processing.

In step S42, the cool-channel two-point calibration processing unit 232 sets the indicating value of the A1DAC 133 to the PL as predetermined power P1PWR for calibration processing of the cool channel. That is to say, the target value of the APC at this time is set to the PL. Upon setting the target value, in step S43 the cool-channel two-point calibration processing unit 232 controls each unit to perform APC control.

The comparator 134 compares the output voltage of the amplifier 132, and voltage equivalent to the P1PWR output from the A1DAC 133, and supplies the difference value thereof to the control voltage adjustment unit 135. The control voltage adjustment unit 135 selects the difference value of the comparator 134 as input, and adjusts the control voltage VRDC according to the value thereof. The adjusted control voltage VRDC is output from the cool channel to the LDD 144 by the electronic switch (SW) 139 as the control voltage WDC5. That is to say, APC control relating to cool power is performed.

In Step S44, the cool-channel two-point calibration processing unit 232 controls the AD 141 to convert the control voltage VRDC into a digital value PLINTMON (FIG. 13), and extracts this. Upon obtaining the PLINTMON, the cool-channel tow-point calibration processing unit 232 advances the processing to step S45, and sets the indicating value of the A1DAC 133 to the PH as predetermined power PLPWR used for cool-channel calibration processing this time. That is to say, the target value of APC at this time is set to the PH. Upon setting the target value, in step S46 the cool-channel two-point calibration processing unit 232 controls each unit to perform APC control in the same way as in the case of step S43, and in step S47 controls the AD 141 to convert the control voltage VRDC into a digital value P1INTMON (FIG. 13), and extracts this, in the same way as in the case of step S44.

Upon obtaining the control voltage VRDC (P1INTMON) with the target values PL and PH, in step S48 the cool-channel two-point calibration processing unit 232 calculates the control voltage WDC5 (WDC5@PC) of the cool channel when a target value is set to the target value PC at the time of output of cool power, and in step S49 employs the calculated WDC5@PC to calculate the indicating value P1INISET@WR of the B2DAC 137 at the time of the writing processing.

Upon calculating the P1INISET@WR, the cool-channel two-point calibration processing unit 232 ends the cool-channel two-point calibration processing, returns the processing to step S2 in FIG. 8, and executes the processing in step S3 and thereafter.

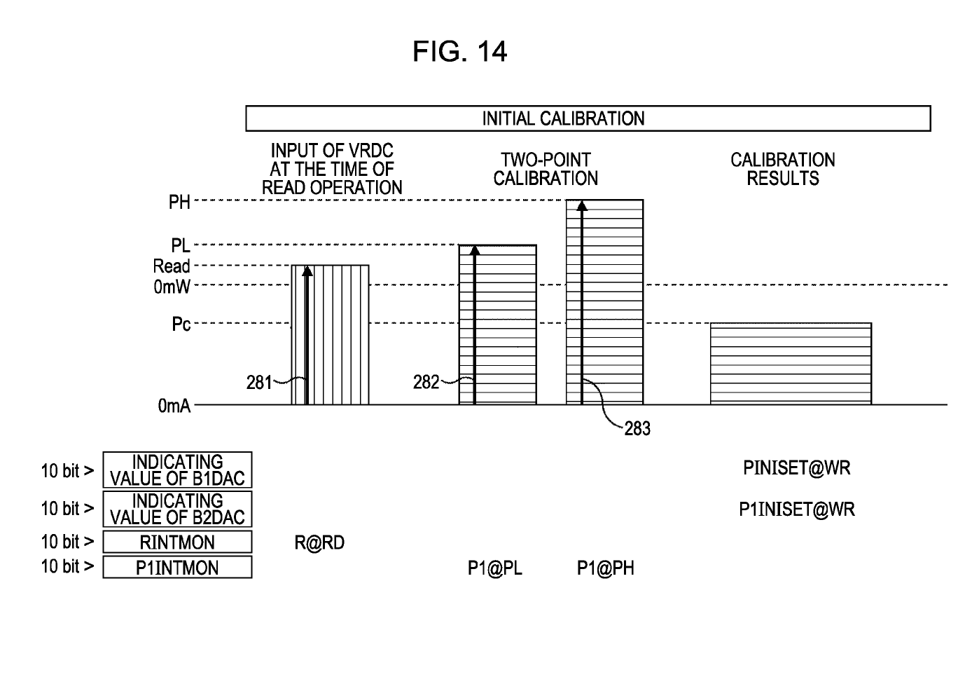

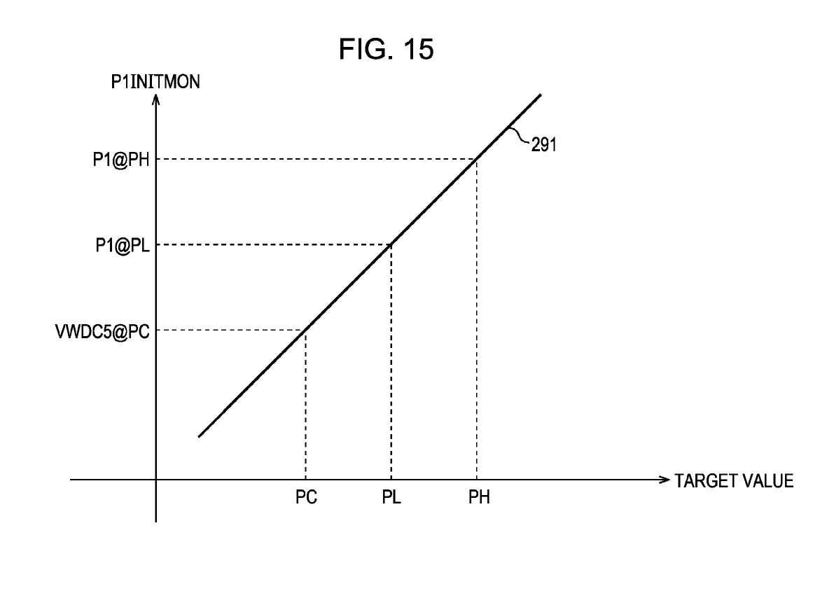

Specific calculation examples of the indicating value of the B1DAC 142 and the indicating value of the B2DAC 137 will be described with reference to FIGS. 14 and 15. FIG. 14 is a schematic view illustrating a situation of the control voltage input processing at the time of read operation and cool-channel two-point calibration processing, of the initial calibration processing, which have been described above.

First, a calculation method of the indicating value of the B1DAC 142 will be described. The AD 141 and B1DAC 142 are both functions included in the same successive comparison A/D converter 136, so the input/output relation between both has been already available. That is to say, the VRDC extraction processing unit 231 can obtain an input digital value such that the B1DAC 142 can output the same voltage as the input voltage of the AD 141 based on a digital value output from the AD 141.

With the control voltage input processing at the time of read operation, let us say that the value of the output digital value RINTMON of the AD 141 extracted as the control voltage VRDC corresponding to read power indicated with an arrow 281 is R@RD. Also, if we say that the output digital value of the AD 141 is the input digital value of the B1DAC 142, let us say that the output voltage of the B1DAC 142 is identical to the input voltage of the AD 141.

Subsequently, if we say that the indicating value of the B1DAC 142 is not changed at the time of the reading processing and writing processing, the indicating value RINISET@WR of the B1DAC 142 at the time of the writing processing can be calculated, for example, as shown in the following Expression (1) by employing the value R@RD of the output voltage RINTMON of the AD 141, obtained with the control voltage input processing at the time of read operation.

RINISET@WR=R@RD (1)

Next, a calculation method of the indicating value of the B2DAC 137 will be described. If we say that the value of the output digital value P1INTMON of the AD 141 corresponding to the target value PL (arrow 282) is P1@PL, and the value of the output digital value P1INTMON of the AD 141 corresponding to the target value PH (arrow 283) is P1@PH, which are obtained by the above-mentioned cool-channel two-point calibration processing, and according to these values, the relation between the target values and the P1INTMON can be represented with a straight line 291 of a graph shown in FIG. 15.

Employing this straight line 291 enables the P1INTMON corresponding to an arbitrary target value to be calculated. That is to say, the control voltage WDC5 (WDC5@PC) of the cool channel when assuming that a target value is the target value PC at the time of output of cool power can be calculated. (As shown in FIG. 13, the control voltage WDC5 is equivalent to the control voltage VRDC, the control voltage VRDC is equivalent to the input digital value RINISET@WR of the B1DAC 142, and the input digital value RINISET of the B1DAC 142 is equivalent to the output digital value RINTMON (P1INTMON) of the AD 141. That is to say, the WDC5@PC is equivalent to the P1INTMON@PC.) At this time, the cool-channel two-point calibration processing unit 232 may create the same table information as the graph shown in FIG. 15 to obtain control voltage VWDC@PC based on the table information thereof, or may calculate the control voltage VWDC@PC by employing the following Expression (2).

$$VWDC 5 @ PC = P 1 @ PL + ( P 1 @ PH - P 1 @ PL ) \times \frac{PC - PL}{PH - PL} \qquad ( 2 )$$

The indicating value P1INISET@WR of the B2DAC 137 at the time of the writing processing can be calculated such as shown in the following Expression (3) from the results of the control voltage input processing at the time of read operation.

P1INISET@WR=RINISET@WR−VWDC5@PC (3)

As described above, the initial calibration processing unit 221 operates in the same way as the operation at the time of the actual writing processing to perform two-point calibration processing, whereby the control of the control voltage WDC5 of the cool channel at the time of the writing processing can be readily calibrated in a more precise manner.

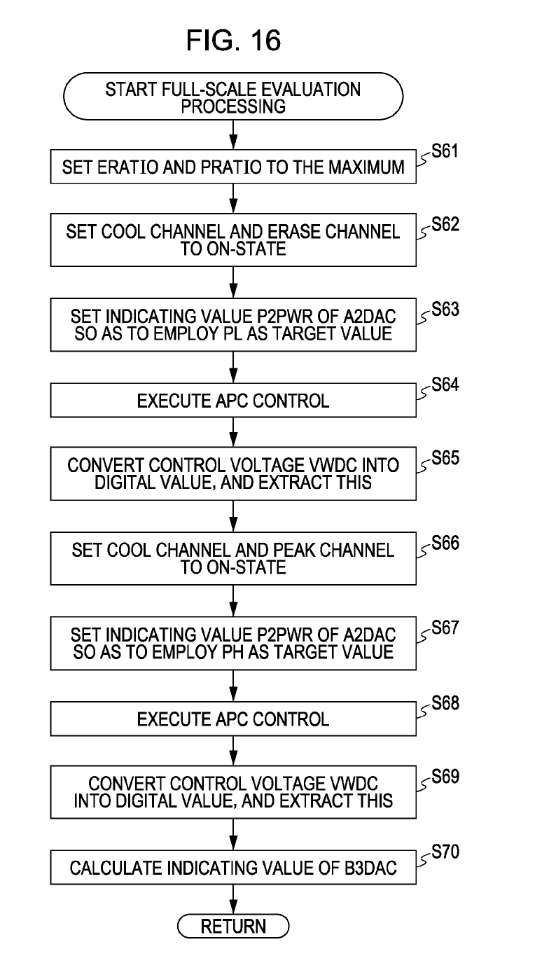

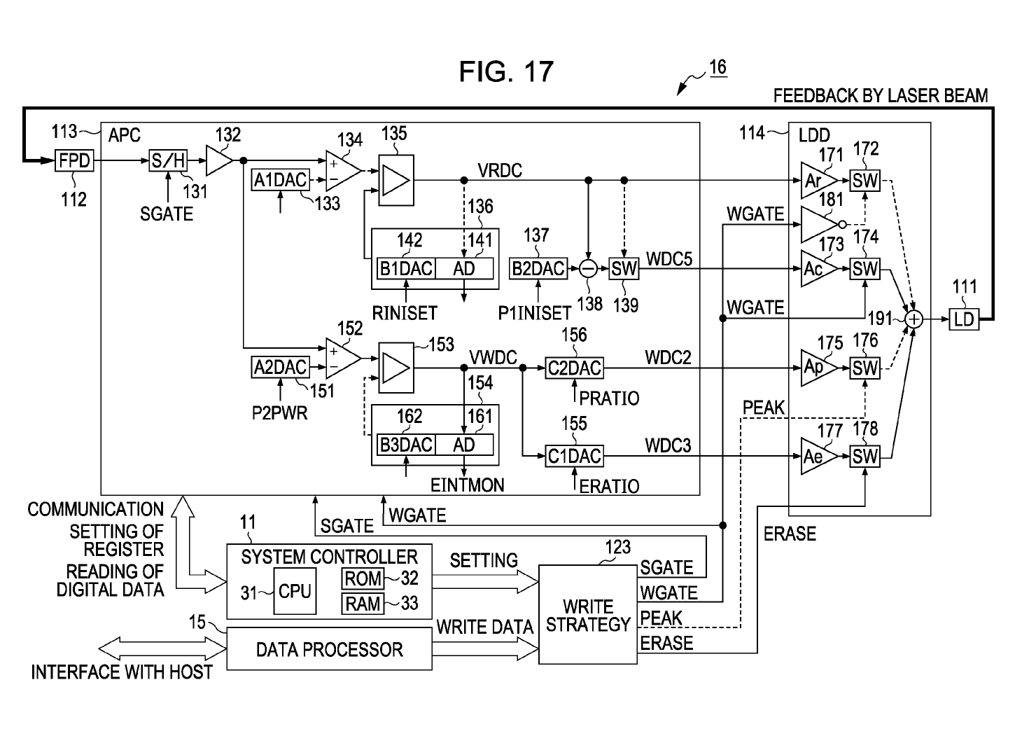

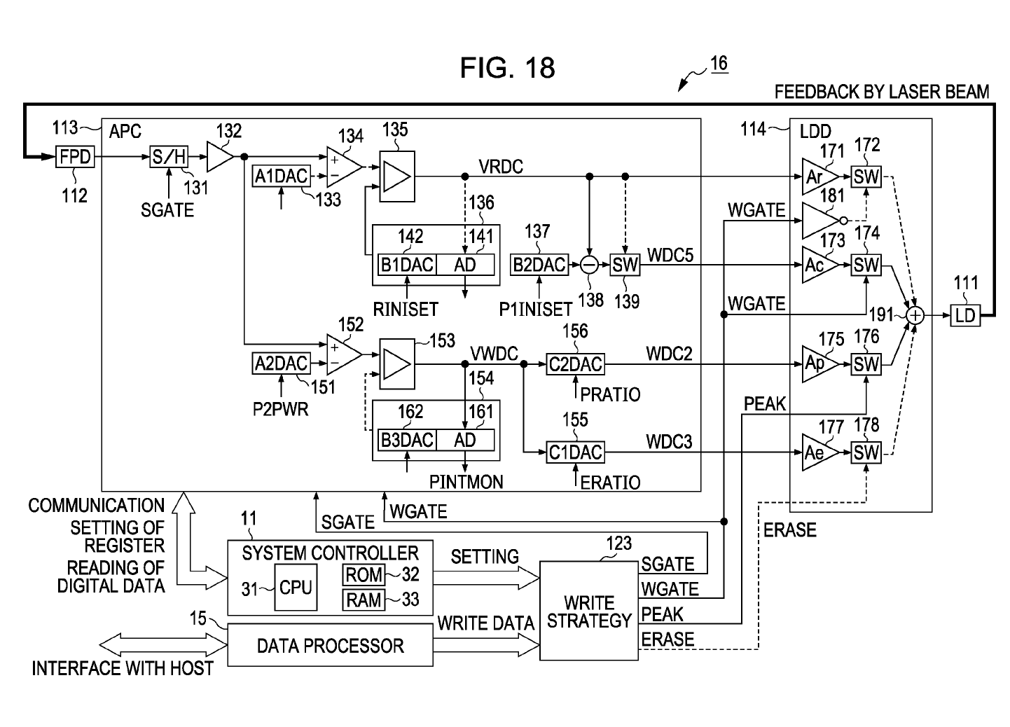

Next, a flow example of the full-scale evaluation processing executed in step S3 in FIG. 8 will be described with reference to the flowchart in FIG. 16. Description will be made with reference to FIGS. 17 and 18 as appropriate. FIG. 17 is a diagram illustrating a situation example of the operation at the time of execution of the full-scale evaluation processing as to the erase channel, of respective units of the optical head unit 16 described with reference to FIG. 2. FIG. 18 is a diagram illustrating a situation example of the operation at the time of execution of the full-scale evaluation processing as to the peak channel, of the respective units of the optical head unit 16 described with reference to FIG. 2.

The full-scale evaluation processing unit 233 perform full-scale evaluation processing for setting the indicating values of the C1DAC 155 and C2DAC 156 so as to effectively utilize the full scales of the C1DAC 155 and C2DAC 156 for determining the ratios (RATIO) of the erase channel and peak channel, respectively. While the other D/A converters of the APC 113 are 10-bit D/A converters, the C1DAC 155 and C2DAC 156 employ a D/A converter of 8-bit resolution, and particularly, it is desirable to utilize the full scales thereof more effectively.

The C1DAC 155 and C2DAC 156 determine a RATIO with the control voltage VWDC, i.e., the output voltage of the B3DAC 162 as reference. Accordingly, for example, if the value of the B3DAC 162 is too small, it is difficult for the C1DAC 155 and C2DAC 156 to set a RATIO to a small value. Conversely, if the value of the B3DAC 162 is too great, it is difficult for the C1DAC 155 and C2DAC 156 to set a RATIO to a great value. That is to say, there is a possibility that only a part of 8-bit resolution which is a narrowed range can be set as the indicating values of the C1DAC 155 and C2DAC 156. In other words, a wider range of the resolution of the C1DAC 155 and C2DAC 156 is assigned to a settable RATIO range, whereby finer RATIO setting can be performed.

Therefore, first, the full-scale evaluation processing unit 233 regards the indicating values of the C1DAC 155 and C2DAC 156, i.e., the RATIOS of the erase channel and peak channel as the maximum (full scale), and obtains the control voltage VWDC at that time (the indicating value of the B3DAC 162) (evaluates the full scale).

Upon the full-scale evaluation processing being started, in step S61 the full-scale evaluation processing unit 233 sets the indicating value ERATIO of the C1DAC 155, and the indicating value PRATIO of the C2DAC 156 to the maximum.

In step S62, the full-scale evaluation processing unit 233 controls the write strategy 123 to set the cool channel and erase channel to ON. As shown in FIG. 17, the write strategy 123 sets the control signals WGATE and ERASE to ON (solid line), and sets the control signal PEAK to OFF (dotted line) based on a request from the full-scale evaluation processing unit 233. Upon the WGATE being set to ON, the read channel goes to an OFF state, and the cool channel goes to an ON state. Thus, each unit of the optical head unit 16 performs the same operation as at the time of emitting a laser beam with erase power of the writing processing. That is to say, the full-scale evaluation processing unit 233 previously performs full-scale evaluation of the C1DAC 155.

In step S63, the full-scale evaluation processing unit 233 sets the indicating value P2PWR of the A2DAC 151 such that the target value PH which is the greater target value of the above-mentioned two-point calibration processing is set as a target value. That is to say, at this time, the target value of the erase channel of APC is set to the PH. The target value at this time may be set to an arbitrary value, but it is desirable to set the target value to a greater value to set the control voltage VWDC to a greater value. Upon setting the target value, in step S64 the full-scale evaluation processing unit 233 controls each unit to perform APC control.

As shown in FIG. 17, the comparator 152 compares the output voltage of the amplifier 132, and voltage equivalent to the P2PWR (PH) output from the A2DAC 151, and supplies the difference value thereof to the control voltage adjustment unit 153. The control voltage adjustment unit 153 selects the difference value of the comparator 152 as input, and adjusts the control voltage VWDC according to the value thereof. The adjusted control voltage VWDC is attenuated by the C1DAC 155, and is output to the LDD 114 from the erase channel as the control voltage WDC3.

Note that at this time, as shown in FIG. 17, the control voltage WDC5 of the cool channel is set as a fixed value. That is to say, the indicating value of the A1DAC 133 is not set, and the indicating value RINISET of the B1DAC 142 is set to the RINISET@WR obtained by the control voltage input processing at the time of read operation. Also, the indicating value P1INISET of the B2DAC 137 is set to the P1INISET@WR obtained by the cool-channel two-point calibration processing. The electronic switch (SW) 139 selects the output of the subtracter 138. That is to say, the control voltage WDC5 becomes RINISET@WR−P1INISET@WR.

That is to say, with the adder 191 of the LDD 114, the current based on the control voltage WDC5 of the cool channel, and the current based on the control voltage WDC3 of the erase channel are added, and supplied to the LD 111. That is to say, APC control relating to erase power is performed.

In step S65, the full-scale evaluation processing unit 233 controls the AD 161 to convert the control voltage VWDC into a digital value EINTMON (FIG. 17), and extracts this. Upon obtaining the EINTMON, the full-scale evaluation processing unit 233 performs the evaluation of the full scale of the C2DAC 156 this time.

In step S66, the full-scale evaluation processing unit 233 controls the write strategy 123 to set the cool channel and peak channel to ON. As shown in FIG. 18, the write strategy 123 sets the control signals WGATE and PEAK to ON (solid line), and sets the control signal ERASE to OFF (dotted line) based on a request from the full-scale evaluation processing unit 233. Upon the WGATE being set to ON, the read channel goes to an OFF state, and the cool channel goes to an ON state. Thus, each unit of the optical head unit 16 performs the same operation as at the time of emitting a laser beam with peak power of the writing processing.

In step S67, the full-scale evaluation processing unit 233 sets the indicating value P2PWR of the A2DAC 151 to the PH in the same way as in the case of step S63. That is to say, at this time as well, the target value of the peak channel of APC is set to the PH. The target value at this time may be set to an arbitrary value, but it is desirable to set the target value to a greater value to set the control voltage VWDC to a greater value. Upon setting the target value, in step S68 the full-scale evaluation processing unit 233 controls each unit to perform APC control.

As shown in FIG. 18, the operation of each unit of the APC 113 at this time is the same as in the case of FIG. 17. With the adder 191 of the LDD 114, the current based on the control voltage WDC5 of the cool channel, and the current based on the control voltage WDC2 of the peak channel are added, and supplied to the LD 111. That is to say, APC control relating to peak power is performed.

In step S69, the full-scale evaluation processing unit 233 controls the AD 161 to convert the control voltage VWDC into a digital value PINTMON (FIG. 18), and extracts this. Upon obtaining the PINTMON, in step S70 the full-scale evaluation processing unit 233 calculates the indicating value P2INISET of the B3DAC 162 based on the EINTMON and PINTMON (Expression (4)).

P2INISET@WR=f(E@PH, P@PH) (4)

In Expression (4), P2INISET@WR represents the indicating value of the B3DAC 162 at the time of the writing processing, E@PH represents the EINTMON when the target value is set to the PH, and the ERATIO is set to the maximum, P@PH represents the PINTMON when the target value is set to the PH, and the PRATIO is set to the maximum, and f(A, B) represents a function wherein A and B are variables. Note that any kind of function may be employed as this function. As for an example of this function, a function can be exemplified wherein of the estimate values of the EINTMON and PINTMON in a case in which the maximum power setting to be set to each of the erase and peak channels is performed, a value obtained, for example, by adding a margin of 10 or so to the greater estimate value thereof is output as a result.

Note that in the same way as in the case of the successive comparison A/D converter 136, if the output digital value of the AD 161 is the input digital value of the B3DAC 162, we can say that the output voltage of the B3DAC 162 is identical to the input voltage of the AD 161.

Upon calculating the P2INISET@WR, the full-scale evaluation processing unit 233 ends the full-scale evaluation processing, returns the processing to step S3 in FIG. 8, and executes the processing in step S4 and thereafter.

The erase-channel two-point calibration phase-1 processing unit 234 performs erase channel control calibration processing, and the peak-channel two-point calibration phase-1 processing unit 235 performs peak channel control calibration processing, based on the evaluation results of such a full scale, respectively.

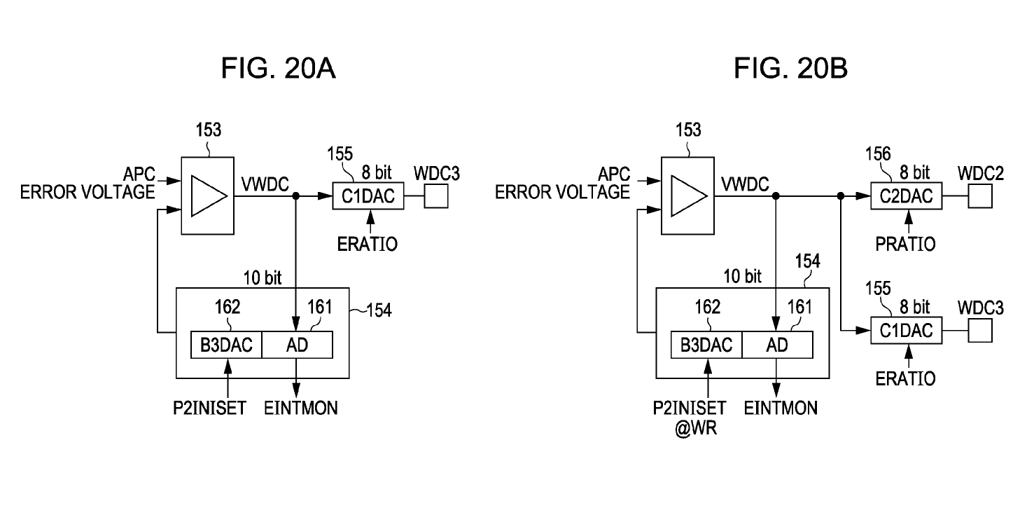

Next, a flow example of the erase-channel two-point calibration phase-1 processing executed in step S4 in FIG. 8 will be described with reference to the flowchart in FIG. 19. Description will be made with reference to FIGS. 17 and 20 as appropriate. That is to say, the optical head unit 16 at the time of executing the erase-channel two-point calibration phase-1 processing basically operates in the same way as at the time of executing the full-scale evaluation processing as to the erase channel. That is to say, in this case as well, the APC 113 operates in the same way as at the time of the writing processing.

The erase-channel two-point calibration phase-1 processing unit 234 calibrates the erase channel by two-point calibration employing the target values PL and PH in the same way as the cool-channel two-point calibration processing. However, in the case of the erase channel, different from the case of the cool channel, the B3DAC 162 common to the peak channel is employed as a D/A converter for setting an initial value, and the control of the erase channel alone is performed with the indicating value ERATIO of the C1DAC 155 which is a DAC for RATIO. Accordingly, the calibration of the control of the erase channel is performed with the calibration of the indicating value ERATIO of the C1DAC 155.

Incidentally, FIG. 20A is a diagram extracting and illustrating components relating to the erase channel of the APC 113 in FIG. 2, but for example, if a value “200” is set as the P2INISET, and a value “100” is set as the ERATIO, the control voltage WDC3 of the erase channel is represented such as shown in the following Expression (5).

VWDC3=K(200×100) (5)

where

P2INISET=200, and ERATIO=100.

In Expression (5), K(X) represents a value proportional to X. That is to say, the control voltage WDC3 is proportional to the product between the P2INISET and ERATIO. Accordingly, for example, as shown in Expression (6), the value of the control voltage WDC3 is not changed even if the values of the P2INISET and ERATIO are replaced.

VWDC3=K(100×200) (6)

where

P2INISET=100, and ERATIO=200.

That is to say, the P2INISET and ERATIO are replaceable. Also, as described above, if we say that the output digital value of the AD 161 is the input digital value of the B3DAC 162, the output voltage of the B3DAC 162 is identical to the input voltage of the AD 161. That is to say, the value of the ERATIO can be calibrated by employing the control voltage VWDC (output digital value of AD 161) which has actually been subjected APC control.

FIG. 20B is a diagram extracting and illustrating components relating to the erase channel and peak channel of the APC 113 in FIG. 2. As described above, the P2INISET@WR is a fixed value optimized with the full scales of the ERATIO and PRATIO by the full-scale evaluation processing. Accordingly, the ERATIO can be suitably calibrated by obtaining the ERATIO corresponding to the P2INISET@WR.

Therefore, the erase-channel two-point calibration phase-1 processing unit 234 performs the two-point calibration processing of the ERATIO by utilizing such replacement, and employing the output digital value of the AD 161.

Upon the erase-channel two-point calibration phase-1 processing being started, in step S91 the erase-channel two-point calibration phase-1 processing unit 234 controls the write strategy 123 to set the cool channel and erase channel to ON in the same way as in step S62 in FIG. 16. That is to say, each unit of the optical head unit 16 basically performs operation at the time of emitting a laser beam with cool power of the writing processing.

In step S92, the erase-channel two-point calibration phase-1 processing unit 234 sets the ERATIO based on the indicating value P2INISET@WR of the B3DAC 162 at the time of the writing processing, obtained by the full-scale evaluation processing. Specifically, the resolution of the B3DAC 162 is 10 bits, and the resolution of the C1DAC 155 is 8 bits, so the erase-channel two-point calibration phase-1 processing unit 234 sets P2INISET@WR/4 as the ERATIO.

Upon setting the ERATIO, in step S93 the erase-channel two-point calibration phase-1 processing unit 234 sets the PL as the indicating value P2PWR of the A2DAC 151. That is to say, at this time the target value of APC is set to the PL. Upon setting the target value, in step S94 the erase-channel two-point calibration phase-1 processing unit 234 controls each unit to perform APC control. Each unit of the optical head unit 16 operates in the same way as at the time of the writing processing, as described with reference to FIG. 17. That is to say, APC control relating to erase power is performed.

In Step S95, the erase-channel two-point calibration phase-1 processing unit 234 controls the AD 161 to convert the control voltage VWDC into a digital value EINTMON (FIG. 17), and extracts this. Upon obtaining the EINTMON (E@PL), in step S96, as shown in Expression (7), the erase-channel two-point calibration phase-1 processing unit 234 replaces the ERATIO with the E@PL thereof, and calculates ERATIO@PL which is ERATIO when employing the PL as the target value.

ERATIO@PL=E@PL/4 (7)

Upon obtaining the ERATIO when employing the PL as the target value, next, the erase-channel two-point calibration phase-1 processing unit 234 calculates the ERATIO when employing the PH as the target value.

In step S97, the erase-channel two-point calibration phase-1 processing unit 234 sets the PH as the indicating value P2PWR of the A2DAC 151. That is to say, at this time the target value of APC is set to the PH. Upon setting the target value, in step S98 the erase-channel two-point calibration phase-1 processing unit 234 controls each unit to perform APC control. In this case as well, each unit of the optical head unit 16 operates in the same way as at the time of the writing processing, as described with reference to FIG. 17, and APC control relating to erase power is performed.

In Step S99, the erase-channel two-point calibration phase-1 processing unit 234 controls the AD 161 to convert the control voltage VWDC into a digital value EINTMON (FIG. 17), and extracts this. Upon obtaining the EINTMON (E@PH), in step S100, as shown in Expression (8), the erase-channel two-point calibration phase-1 processing unit 234 replaces the ERATIO with the E@PH thereof, and calculates ERATIO@PH which is ERATIO when employing the PH as the target value.

ERATIO@PH=E@PH/4 (8)

Upon obtaining the ERATIO when employing the PH as the target value, the erase-channel two-point calibration phase-1 processing unit 234 ends the erase-channel two-point calibration phase-1 processing, returns the processing to step S4 in FIG. 8, and executes the processing in step S5 and thereafter.

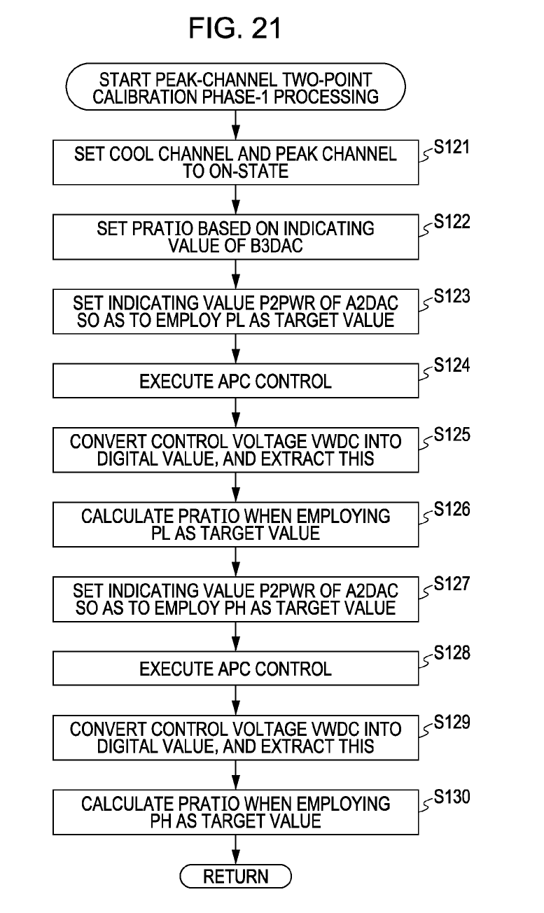

Next, a flow example of the peak-channel two-point calibration phase-1 processing executed in step S5 in FIG. 8 will be described with reference to the flowchart in FIG. 21. Description will be made with reference to FIG. 18 as appropriate. That is to say, the optical head unit 16 at the time of executing the peak-channel two-point calibration phase-1 processing basically operates in the same way as at the time of executing the full-scale evaluation processing as to the peak channel. That is to say, in this case as well, the APC 113 operates in the same way as at the time of the writing processing.

The peak-channel two-point calibration phase-1 processing unit 235 calibrates the peak channel by two-point calibration employing the target values PL and PH in the same way as the cool-channel two-point calibration processing. In the same way as in the case of the erase channel, the calibration of the control of the peak channel is performed with the calibration of the indicating value PRATIO of the C2DAC 156 which is a D/A converter for RATIO. A method for the calibration thereof is basically the same as in the case of the ERATIO described with reference to FIG. 20.

Upon the peak-channel two-point calibration phase-1 processing being started, in step S121, in the same way as in step S66 in FIG. 16, the peak-channel two-point calibration phase-1 processing unit 235 controls the write strategy 123 to set the cool channel and peak channel to ON. That is to say, each unit of the optical head unit 16 basically performs operation at the time of emitting a laser beam with peak power of the writing processing.

In step S122, the peak-channel two-point calibration phase-1 processing unit 235 sets the PRATIO based on the indicating value P2INISET@WR of the B3DAC 162 at the time of the writing processing, obtained by the full-scale evaluation processing (P2INISET@WR/4).

Upon setting the PRATIO, in step S123 the peak-channel two-point calibration phase-1 processing unit 235 sets the PL as the indicating value P2PWR of the A2DAC 151. That is to say, at this time the target value of APC is set to the PL. Upon setting the target value, in step S124 the peak-channel two-point calibration phase-1 processing unit 235 controls each unit to perform APC control. Each unit of the optical head unit 16 operates in the same way as at the time of the writing processing, as described with reference to FIG. 18. That is to say, APC control relating to peak power is performed.

In Step S125, the peak-channel two-point calibration phase-1 processing unit 235 controls the AD 161 to convert the control voltage VWDC into a digital value PINTMON (FIG. 18), and extracts this. Upon obtaining the PINTMON (P@PL), in step S126, as shown in Expression (9), the peak-channel two-point calibration phase-1 processing unit 235 replaces the PRATIO with the P@PL thereof, and calculates PRATIO@PL which is PRATIO when employing the PL as the target value.

PRATIO@PL=P@PL/4 (9)

Upon obtaining the PRATIO when employing the PL as the target value, next, the peak-channel two-point calibration phase-1 processing unit 235 calculates the PRATIO when employing the PH as the target value.

In step S127, the peak-channel two-point calibration phase-1 processing unit 235 sets the PH as the indicating value P2PWR of the A2DAC 151. Upon setting the target value of APC to the PH, in step S128 the peak-channel two-point calibration phase-1 processing unit 235 controls each unit to perform APC control. In this case as well, each unit of the optical head unit 16 operates in the same way as at the time of the writing processing, as described with reference to FIG. 18, and APC control relating to peak power is performed.

In Step S129, the peak-channel two-point calibration phase-1 processing unit 235 controls the AD 161 to convert the control voltage VWDC into a digital value PINTMON (FIG. 18), and extracts this. Upon obtaining the PINTMON (P@PH), in step S130, as shown in Expression (10), the peak-channel two-point calibration phase-1 processing unit 235 replaces the PRATIO with the P@PH thereof, and calculates PRATIO@PH which is PRATIO when employing the PH as the target value.

PRATIO@PH=P@PH/4 (10)

Upon obtaining the ERATIO when employing the PH as the target value, the peak-channel two-point calibration phase-1 processing unit 235 ends the peak-channel two-point calibration phase-1 processing, returns the processing to step S5 in FIG. 8, and executes the processing in step S6 and thereafter.

Upon the first two-point calibration processing (phase 1) being performed regarding each of the erase channel and peak channel, the ERATIO and PRATIO are replaced with the EINTMON and PINTMON calculated with the calibration processing thereof, and second two-point calibration processing (phase 2) is performed.

The first two-point calibration processing has been performed by employing the common value P2INISET@WR as the values of the ERATIO and PRATIO in either case of a case wherein the target value is the PH and a case wherein the target value is the PL. Accordingly, there is a possibility that the values of the calculated ERATIO and PRATIO include an unacceptable level of great error.

Therefore, in order to perform calibration processing in a more precise manner, the erase-channel two-point calibration phase-2 processing unit 236 and peak-channel two-point calibration phase-2 processing unit 237 each perform the same two-point calibration processing (phase 2) as the phase 1 regarding the ERATIO and PRATIO by employing the ERATIO and PRATIO calculated at the phase 1 again.

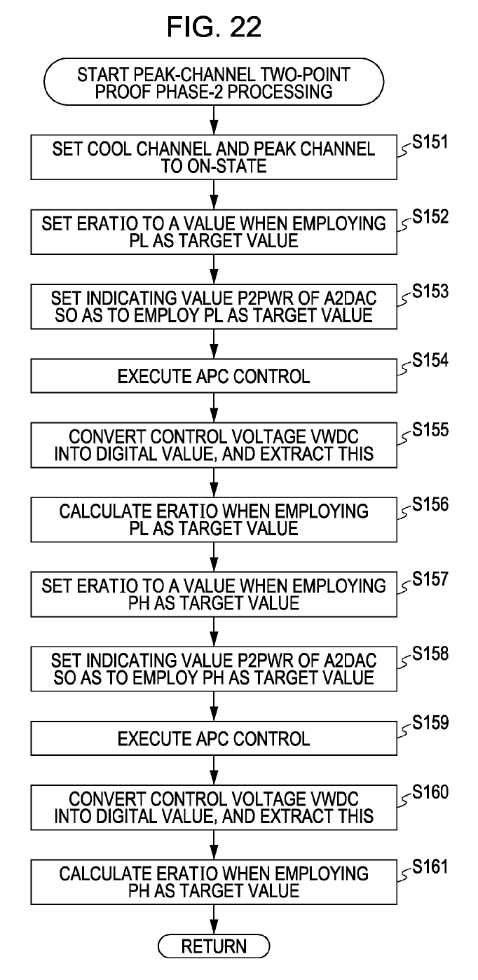

A flow example of the erase-channel two-point calibration phase-2 processing executed in step S6 in FIG. 8 will be described with reference to the flowchart in FIG. 22.

The erase-channel two-point calibration phase-2 processing is basically the same processing as the erase-channel two-point calibration phase-1 processing.

Accordingly, the erase-channel two-point calibration phase-2 processing unit 236 executes each processing in steps S151 through S161 basically in the same way as in steps S91 through S100 in FIG. 19. However, in the case of the phase 2, the value of the ERATIO is changed depending on whether the PL or PH is employed as the target value.

That is to say, after performing the processing in step S151 in the same way as in step S91 in FIG. 19, in step S152 the erase-channel two-point calibration phase-2 processing unit 236 sets the indicating value ERATIO of the C1DAC 155 to the ERATIO when employing the PL as the target value (ERATIO@PL) obtained with the phase 1. The erase-channel two-point calibration phase-2 processing unit 236 employs the ERATIO thereof to perform the processing in steps S153 through S156 in the same way as in the case of steps S93 through S96 in FIG. 19, and calculates a new ERATIO when employing the PL as the target value (new ERATIO@PL).

Subsequently, in step S157, the erase-channel two-point calibration phase-2 processing unit 236 sets the indicating value ERATIO of the C1DAC 155 to the ERATIO when employing the PH as the target value (ERATIO@PH) obtained with the phase 1. The erase-channel two-point calibration phase-2 processing unit 236 employs the ERATIO thereof to perform the processing in steps S158 through S161 in the same way as in the case of steps S97 through S100 in FIG. 19, and calculates a new ERATIO when employing the PH as the target value (new ERATIO@PH).

Upon obtaining the ERATIO when employing the PH as the target value, the erase-channel two-point calibration phase-2 processing unit 236 ends the erase-channel two-point calibration phase-2 processing, returns the processing to step S6 in FIG. 8, and executes the processing in step S7 and thereafter.

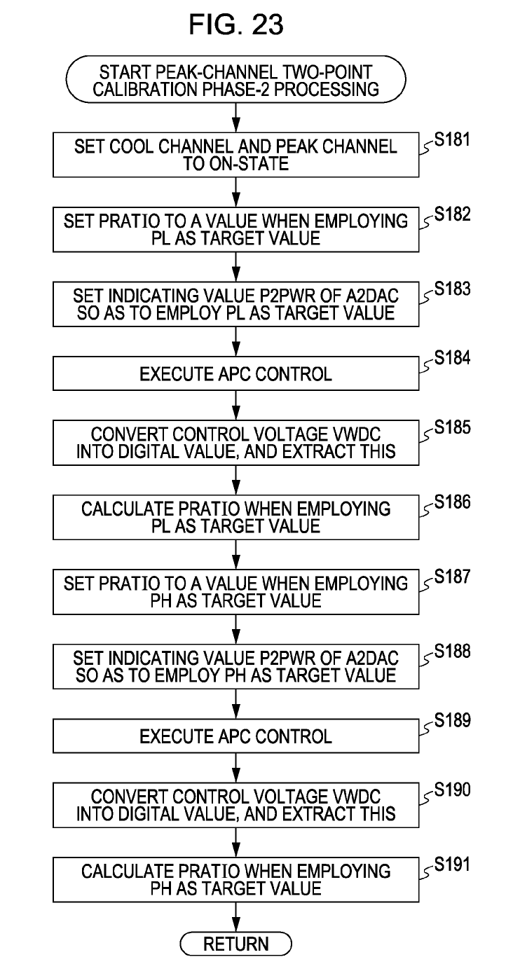

A flow example of the peak-channel two-point calibration phase-2 processing executed in step S7 in FIG. 8 will be described with reference to the flowchart in FIG. 23.

The peak-channel two-point calibration phase-2 processing is basically the same processing as the peak-channel two-point calibration phase-1 processing. Accordingly, the peak-channel two-point calibration phase-2 processing unit 237 executes each processing in steps S181 through S191 basically in the same way as in steps S121 through S130 in FIG. 21. However, in the case of the phase 2, the value of the PRATIO is changed depending on whether the PL or PH is employed as the target value.

That is to say, after performing the processing in step S181 in the same way as in step S121 in FIG. 21, in step S182 the peak-channel two-point calibration phase-2 processing unit 237 sets the indicating value PRATIO of the C2DAC 156 to the PRATIO when employing the PL as the target value (PRATIO@PL) obtained with the phase 1. The peak-channel two-point calibration phase-2 processing unit 237 employs the PRATIO thereof to perform the processing in steps S183 through S186 in the same way as in the case of steps S123 through S126 in FIG. 21, and calculates a new PRATIO when employing the PL as the target value (new PRATIO@PL).

Subsequently, in step S187, the peak-channel two-point calibration phase-2 processing unit 237 sets the indicating value PRATIO of the C2DAC 156 to the PRATIO when employing the PH as the target value (PRATIO@PH) obtained with the phase 1. The peak-channel two-point calibration phase-2 processing unit 237 employs the PRATIO thereof to perform the processing in steps S188 through S191 in the same way as in the case of steps S127 through S130 in FIG. 21, and calculates a new PRATIO when employing the PH as the target value (new PRATIO@PH).

Upon obtaining the PRATIO when employing the PH as the target value, the peak-channel two-point calibration phase-2 processing unit 237 ends the peak-channel two-point calibration phase-2 processing, returns the processing to step S7 in FIG. 8, and executes the processing in step S8 and thereafter.

In step S8 in FIG. 8, the RATIO setting processing unit 238 employs the thus calculated EINTMON and PINTMON corresponding to the target values PL and PH to obtain the ERATIO (ERATIO@PL and ERATIO@PH) and PRATIO (PRATIO@PL and PRATIO@PH) corresponding to the target values PL and PH, and further employs these values to calculate an ERATIO (ERATIO@WR) and PRATIO (PRATIO@WR) corresponding to the P2INISET@WR calculated with the full-scale evaluation processing, and sets these.

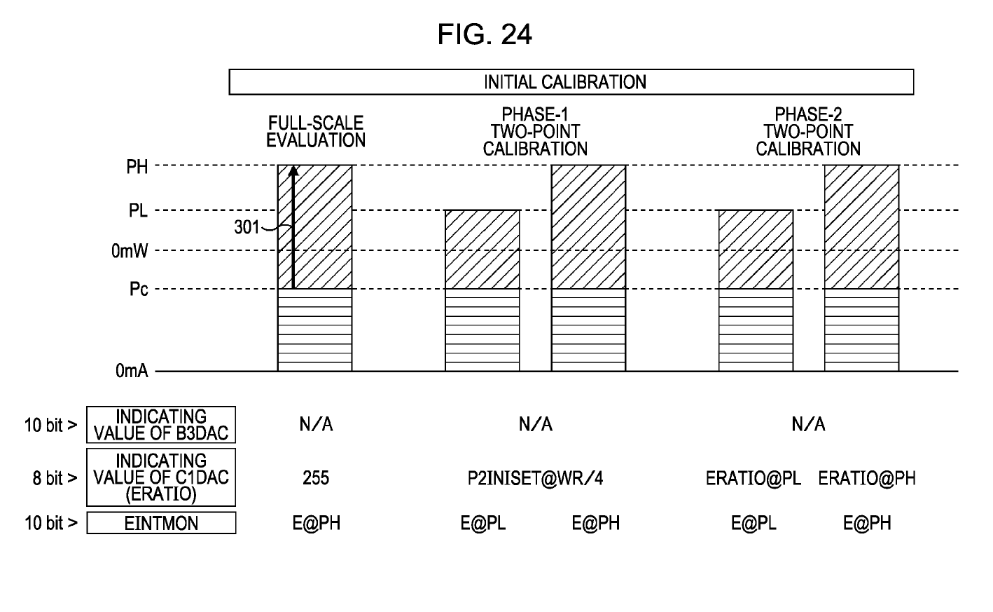

The calculation method thereof will be described in a specific manner. First, description will be made regarding the ERATIO@WR with reference to FIG. 24.

As shown in FIG. 24, with the full-scale evaluation processing, the value of the indicating value ERATIO of the C1DAC 155 of 8-bit resolution is set to 255, and the output EINTMON of the AD 161 corresponding to the target value PH (arrow 301) is obtained (E@PH). Subsequently, with the two-point calibration processing phase 1, according to replacement, the value of the ERATIO is set to the P2INISET@WR/4, i.e., set to ¼ of the E@PH obtained with the full-scale evaluation processing, and the output EINTMON of the AD 161 corresponding to the target values PL and PH is obtained (E@PL and E@PH), respectively. Further, with the two-point calibration processing phase-2, according to replacement, the ERATIO when employing the PL as the target value is set with Expression (7), and the ERATIO (ERATIO@PH) when employing the PH as the target value is set with Expression (8). Subsequently, the output EINTMON of the AD 161 corresponding to the target values PL and PH is obtained (E@PL and E@PH) by employing each ERATIO, respectively.

With the phases 1 and 2, the ratio between the ERATIO and EINTMON is constant, so the RATIO setting processing unit 238 can update the ERATIO corresponding to the target value PL based on the processing result of the phase 2, such as shown in the following Expression (11).

$$ERATIO @ PL = \frac{ERATIO @ PL \times E @ PL}{P 2 INISET @ WR} \qquad ( 11 )$$

Similarly, the RATIO setting processing unit 238 can update the ERATIO corresponding to the target value PH based on the processing result of the phase 2, such as shown in the following Expression (12).

$$ERATIO @ PH = \frac{ERATIO @ PH \times E @ PH}{P 2 INISET @ WR} \qquad ( 12 )$$

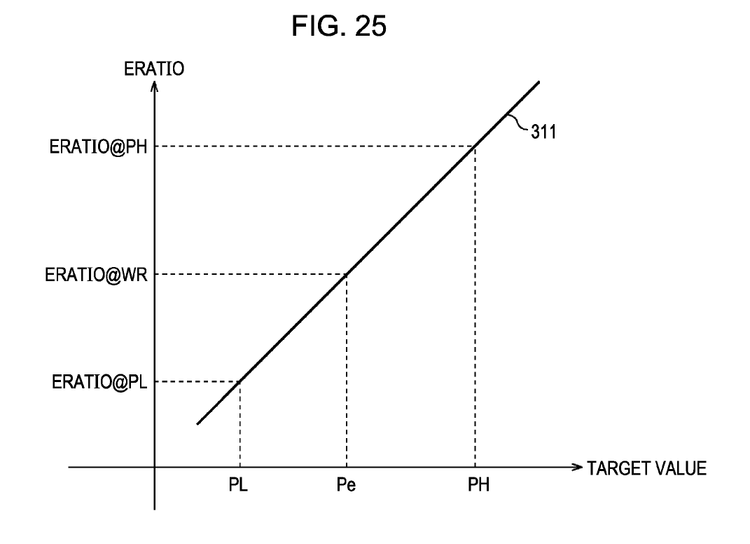

The relation between the target value and ERATIO can be represented with a straight line 311 of the graph shown in FIG. 25 by employing the ERATIO@PL and ERATIO@PH.

The RATIO setting processing unit 238 can calculate the ERATIO corresponding to an arbitrary target value by employing this straight line 311 (two-point calibration). That is to say, for example, the ERATIO (ERATIO@WR) when employing erase power Pe as the target value can be calculated. At this time, the RATIO setting processing unit 238 may create table information equivalent to the graph shown in FIG. 25 to obtain the ERATIO@WR based on the table information thereof, or may calculate the ERATIO@WR by employing the following Expression (13).

$$ERATIO = ERATIO @ PL + ( \begin{matrix}ERATIO @ PH - \\ ERATIO @ PL\end{matrix} ) \times \frac{Pe - PL}{PH - PL} \qquad ( 13 )$$

Note that Pe in Expression (13) represents erase power.

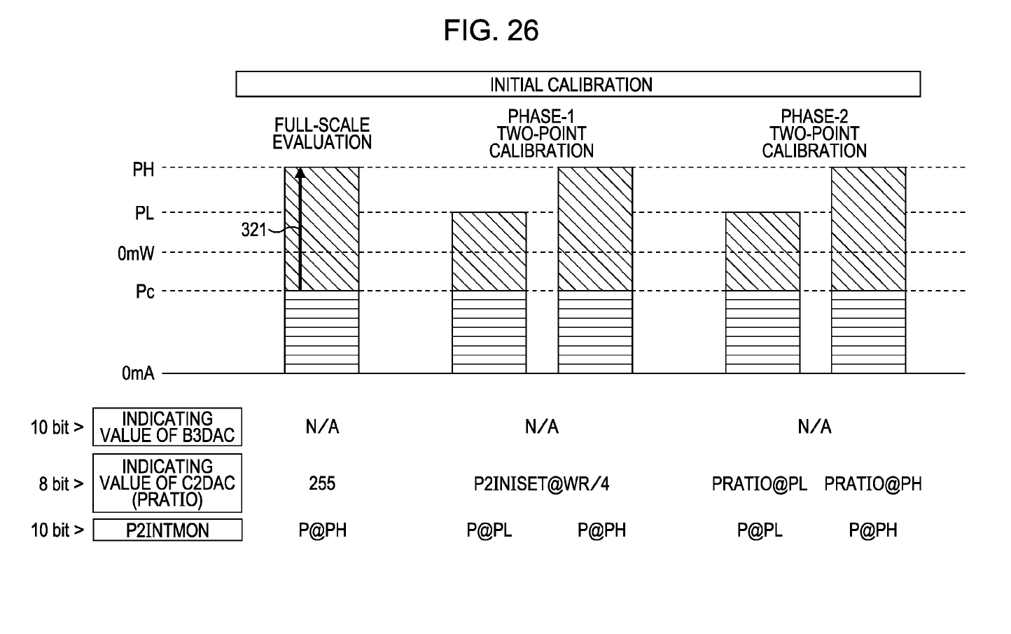

Also, as shown in FIG. 26, the RATIO setting processing unit 238 can obtain the PRATIO@WR in the same way as in the case of the ERATIO@WR. That is to say, as shown in FIG. 26, with the full-scale evaluation processing, the value of the indicating value PRATIO of the C2DAC 156 of 8-bit resolution is set to 255, and the output PINTMON of the AD 161 corresponding to the target value PH (arrow 321) is obtained (P@PH). Subsequently, with the two-point calibration processing phase 1, according to replacement, the value of the PRATIO is set to the P2INISET@WR/4, i.e., set to ¼ of the P@PH obtained with the full-scale evaluation processing, and the output PINTMON of the AD 161 corresponding to the target values PL and PH is obtained (P@PL and P@PH), respectively. Further, with the two-point calibration processing phase-2, according to replacement, the PRATIO (PRATIO@PL) when employing the PL as the target value is set with Expression (9), and the PRATIO when employing the PH as the target value is set with Expression (10). Subsequently, the output PINTMON of the AD 161 corresponding to the target values PL and PH is obtained (P@PL and P@PH) by employing each PRATIO, respectively.

With the phases 1 and 2, the ratio between the PRATIO and PINTMON is constant, so the RATIO setting processing unit 238 can update the PRATIO corresponding to the target value PL based on the processing result of the phase 2, such as shown in the following Expression (14).

$$PRATIO @ PL = \frac{PRATIO @ PL \times P @ PL}{P 2 INISET @ WR} \qquad ( 14 )$$

Similarly, the RATIO setting processing unit 238 can update the PRATIO corresponding to the target value PH based on the processing result of the phase 2, such as shown in the following Expression (15).

$$PRATIO @ PH = \frac{PRATIO @ PH \times P @ PH}{P 2 INISET @ WR} \qquad ( 15 )$$

The relation between the target value and PRATIO can be represented with a straight line 311 of the graph shown in FIG. 25 by employing the PRATIO@PL and PRATIO@PH.

The RATIO setting processing unit 238 can calculate the PRATIO corresponding to an arbitrary target value by employing this straight line 311 (two-point calibration). That is to say, for example, the PRATIO when employing peak power Pp as the target value can be calculated. At this time, the RATIO setting processing unit 238 may create table information equivalent to the graph shown in FIG. 25 to obtain the PRATIO@WR based on the table information thereof, or may calculate the PRATIO@WR by employing the following Expression (16).

$$PRATIO = PRATIO @ PL + ( \begin{matrix}PRATIO @ PH - \\ PRATIO @ PL\end{matrix} ) \times \frac{Pp - PL}{PH - PL} \qquad ( 16 )$$

Note that Pp in Expression (16) represents peak power.

As described above, the initial calibration processing unit 221 operates in the same way as the operation at the time of the actual writing processing to perform two-point calibration processing, whereby the control of the control voltage WDC3 of the erase channel and control voltage WDC2 of the peak channel at the time of the writing processing can be readily calibrated in a more precise manner. Also, the two-point calibration processing is performed twice, whereby the calibration processing can be performed in a state taking offset and noise and so forth at the time of the actual writing processing into consideration, and accordingly, the calibration can be performed in a more precise manner.

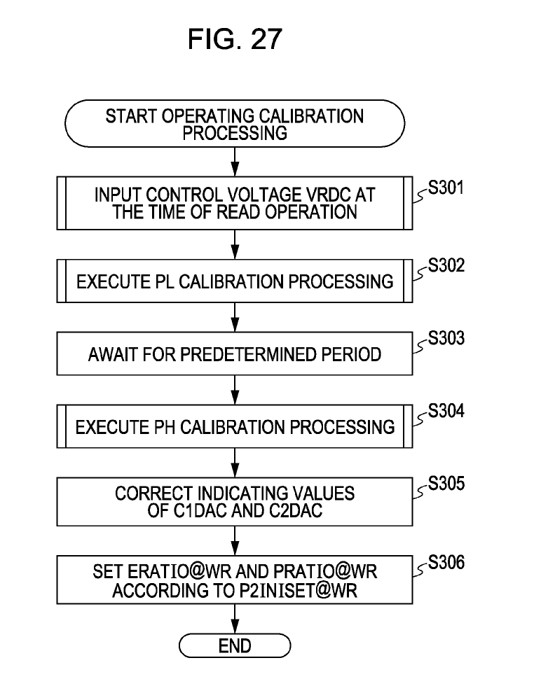

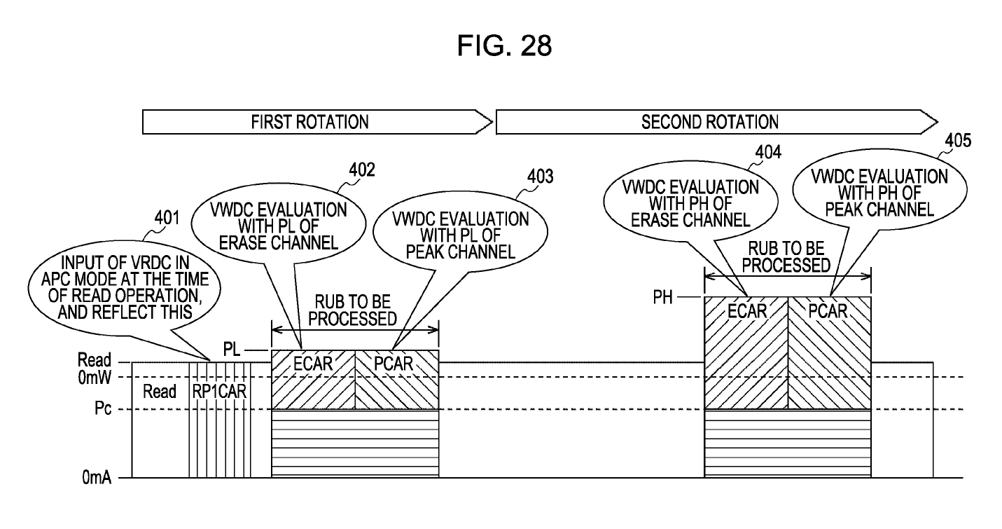

Next, the operating calibration processing will be described with reference to the flowchart in FIG. 27. Description will be made with reference to FIG. 28 as appropriate. As described above, with the operating calibration processing, input of the control voltage VRDC at the time of read operation, and only the phase-2 processing of the two-point calibration processing as to the erase channel and peak channel are performed in the same way as with the initial calibration processing. Also, at the first rotation, of the two-point calibration processing, the processing when employing the PL as the target is performed upon a predetermined RUB of the optical disc previously correctively regarding both of the ERATIO and PRATIO, and at the second rotation, the processing when employing the PH as the target is performed.

Upon the operating calibration processing being started, in step S301, as shown in words balloon 401 in FIG. 28, the VRDC extraction processing unit 241 of the initial calibration processing unit 221 executes the control voltage input processing at the time of read operation for inputting the control voltage VRDC corresponding to read power by the AD 141 as a digital value at the time of read operation, and input the control voltage VRDC at the time of read operation.

In step S302, as shown in words balloons 402 and 403 in FIG. 28, the PL calibration processing unit 242 executes the PL calibration processing when employing the PL as the target value for performing regarding both of the erase channel and peak channel correctively. This processing is performed at the time of the first rotation after starting the operating calibration processing as to a particular RUB of the optical disc 21.

Note that the control voltage input processing at the time of read operation to be executed in step S301 is performed upon a RUB positioned predetermined distance before a predetermined RUB, which performs the two-point calibration processing. The position where the control voltage input processing at the time of read operation is performed is arbitrary, but if the time difference between the control voltage input processing at the time of read operation is excessively long, there is a possibility that operation temperature or the like is changed, so it is desirable to perform the control voltage input processing at the time of read operation before a RUB where the PL calibration processing is performed, at a position near the RUB thereof.

Also, as shown in FIG. 28, with a part of the RUB to be processed, the calibration processing as to the erase channel is performed first, and with a part of the remaining part, the calibration processing as to the peak channel is performed.

Upon the PL calibration processing being ended, in step S303 the stand-by processing unit 243 stands by for a predetermined period so as to prevent history effects from occurring on the optical disc 21. The length of this stand-by period is arbitrary, the optical disc 21 may rotate any number of times until the RUB to be subjected to the PL calibration processing starts the PH calibration processing, but if the stand-by period is set to be excessively long, there is a possibility that operation temperature or the like is changed, so it is desirable to set the stand-by time to one rotation or so. Hereafter, let us say that the stand-by period is a period wherein the RUB to be subjected to the PL calibration processing goes round and returns.

Upon the optical disc 21 rotating once, and the LD 111 being located in the RUB to be processed, as shown in words balloons 404 and 405 in FIG. 28, in step S304 the PH calibration processing unit 244 executes the PH calibration processing for performing the calibration processing when employing the PH as the target value regarding both of the erase channel and peak channel correctively.

Also, as shown in FIG. 28, with a part of the RUB to be processed, the calibration processing as to the erase channel is performed first, and with a part of the remaining part, the calibration processing as to the peak channel is performed.

Upon the PH calibration processing being ended, in step S305 the RATIO correction processing unit 245 corrects the indicating value ERATIO (ERATIO@PL and ERATIO@PH) of the C1DAC 155, and the indicating value PRATIO (PRATIO@PL and PRATIO@PH) of the C2DAC 156. In step S306, the RATIO setting processing unit 246 employs the corrected ERATIO and PRATIO thereof to set the ERATIO@WR and PRATIO@WR corresponding to the P2INISET@WR. Upon the processing in step S306 being ended, the operating calibration processing unit 222 ends the calibration processing at the time of operation.

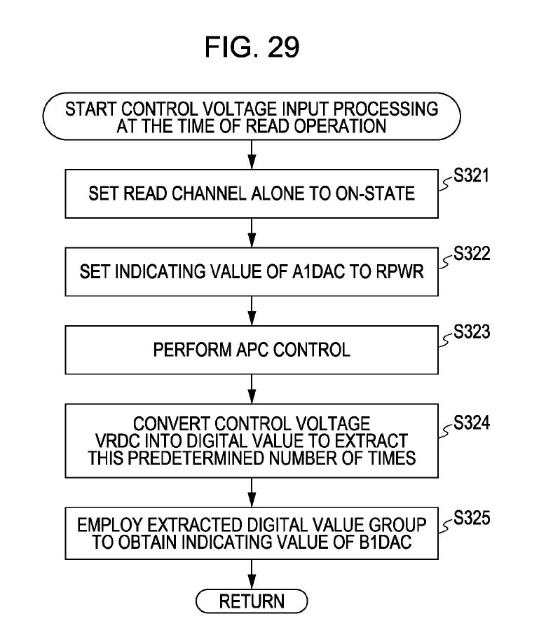

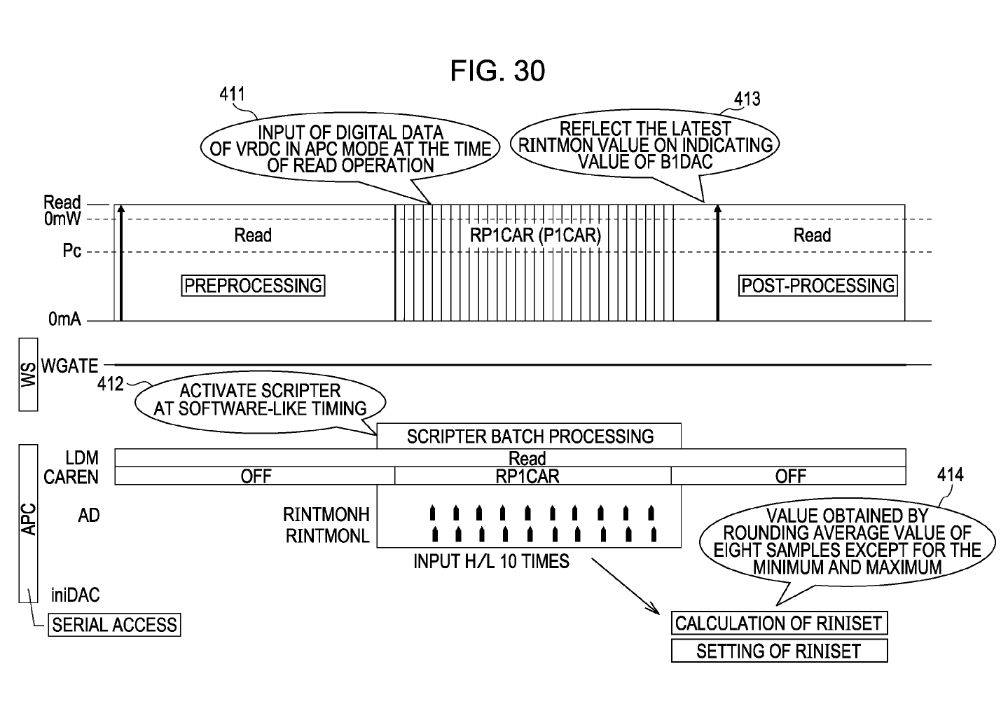

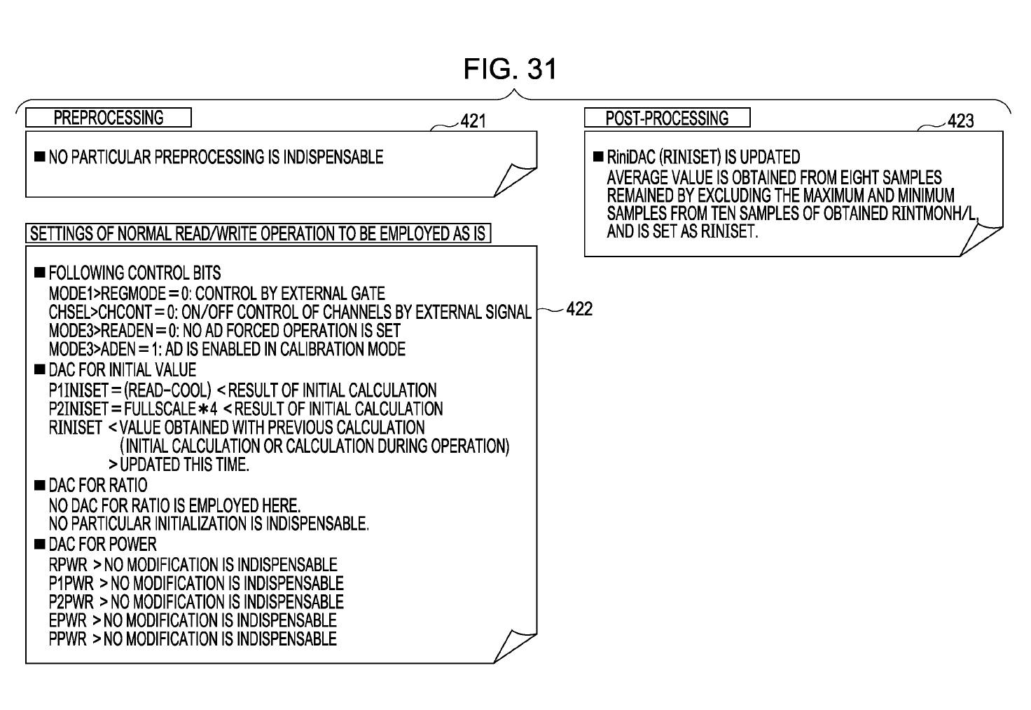

Next, the details of each processing in steps S301 through S306 will be described. First, a flow example of the control voltage input processing at the time of read operation executed in step S301 will be described with reference to the flowchart in FIG. 29. Description will be made with reference to FIGS. 30 and 31 as appropriate. FIG. 30 is a schematic view illustrating a situation example of the control voltage input processing at the time of read operation. FIG. 31 is a diagram for describing the details of the content of the control voltage input processing at the time of read operation.

The control voltage input processing at the time of read operation of the calibration processing at the time of operation is performed basically in the same way as the control voltage input processing at the time of read operation of the initial calibration processing. However, in the case of the calibration processing as the time of operation, the control voltage input processing at the time of read operation is performed while tracing the optical disc 21, and accordingly, input of the control voltage VRDC is performed multiple times to improve precision.

That is to say, the VRDC extraction processing unit 241 performs each processing in steps S321 through S323 in the same way as steps S21 through S23 in FIG. 10. As shown within a frame 421 in FIG. 31, preprocessing before performing input of the control voltage VRDC can be omitted.

Upon APC control relating to read operation being performed, as shown in words balloon 411 in FIG. 30, in step S324 the VRDC extraction processing unit 241 controls the AD 141 to convert the control voltage VRDC into a digital value to extract this a predetermined number of times. In reality, as shown in words balloon 412 in FIG. 30, the VRDC extraction processing unit 241 only activates a scripter for repeatedly obtaining the output digital value RINTMON of the AD 141 at software like timing. At this time, as shown within a frame 422 in FIG. 31, the VRDC extraction processing unit 241 sets each value. That is to say, input of the RINTMON is basically the same as ordinary read operation.

Input of the RINTMON is performed by the scripter thereof. The scripter, for example, repeats input of the RINTMON at the time of read operation ten times.

Upon input being ended, as shown in words balloon 413 in FIG. 30, in step S325 the VRDC extraction processing unit 241 employs the extracted digital value group to obtain the indicating value RINISET of the B1DAC 142 (reflect the value of the latest RINTMON on the RINISET). More specifically, as shown in words balloon 414 in FIG. 30 and within a frame 423 in FIG. 31, of the extracted ten RINTMONS, a value is obtained by rounding the average value of the eight values excluding the minimum value and maximum value, and the value thereof is set to the RINISET.

Upon calculating the indicating value RINISET of the B1DAC 142, the VRDC extraction processing unit 241 returns the processing to step S301 in FIG. 27, and executes the processing in step S302 and thereafter.

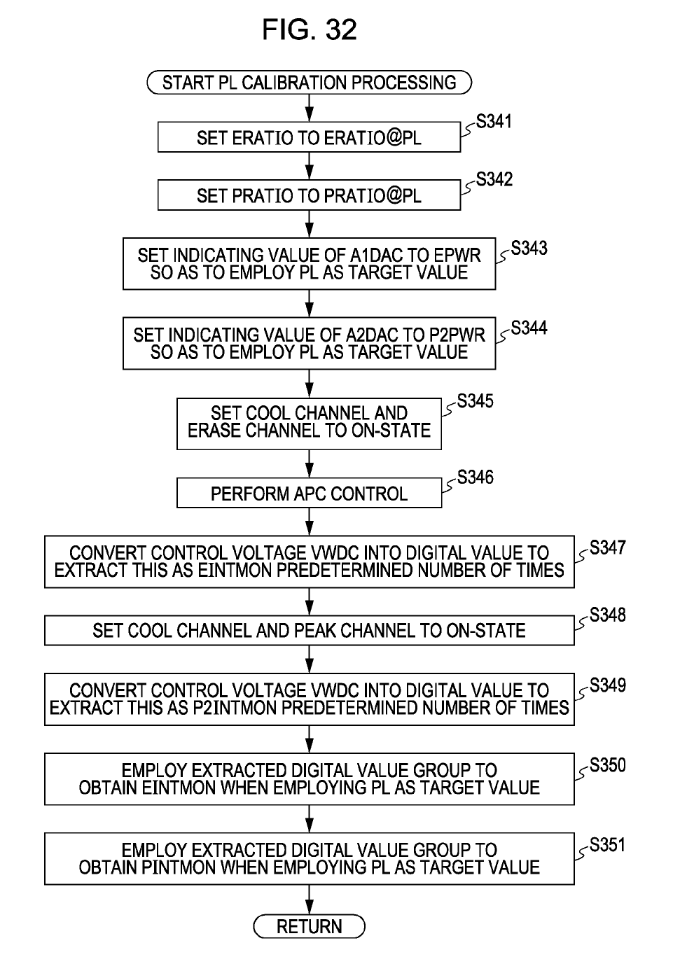

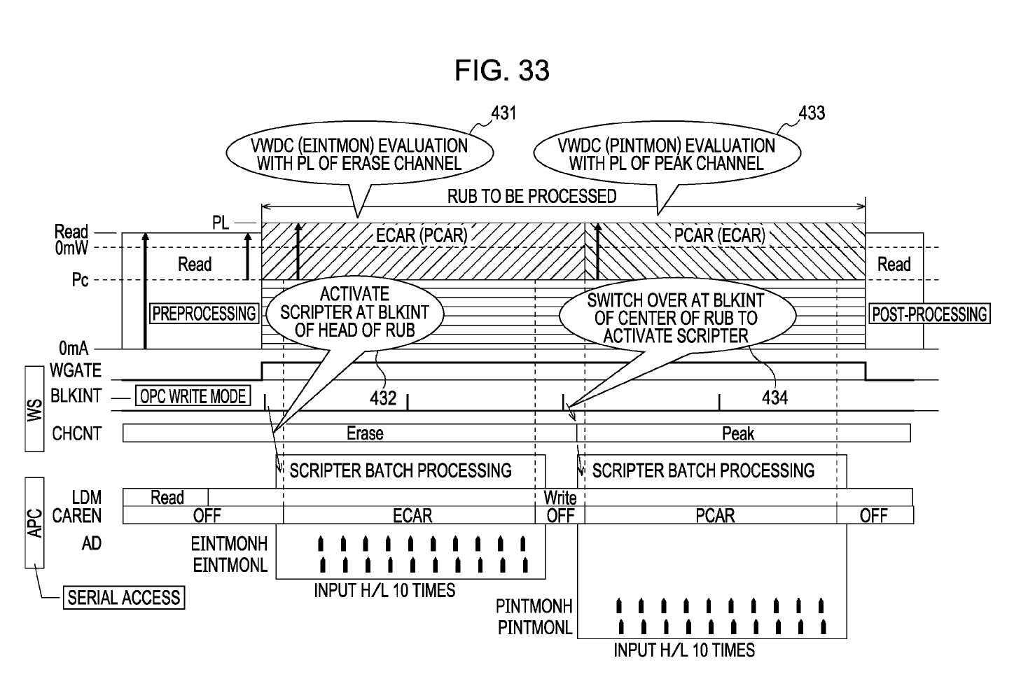

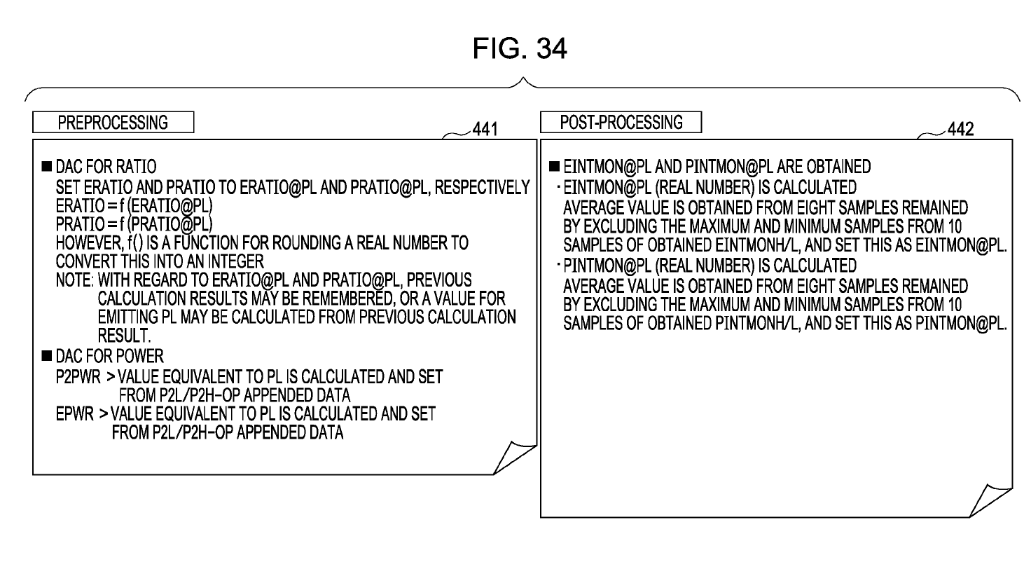

Next, the details of the PL calibration processing executed in step S302 in FIG. 27 will be described with reference to the flowchart in FIG. 32. Description will be made with reference to FIGS. 33 and 34 as appropriate. FIG. 33 is a schematic view illustrating a situation example of the PL calibration processing. FIG. 34 is a diagram for describing the details of the content of the PL calibration processing.

As preprocessing before input of the control voltage VWDC by the AD 161 is performed, in step S341 the PL calibration processing unit 242 sets the indicating value ERATIO of the C1DAC 155 to the ERATIO@PL calculated with the previous PL calibration processing, and in step S342 sets the indicating value PRATIO of the C2DAC 156 to the PRATIO@PL calculated with the previous PL calibration processing.

More specifically, as shown within a frame 441 in FIG. 34, the ERATIO@PL and PRATIO@PL calculated with the previous PL calibration processing are rounded and converted into integers. Note that, with regard to the ERATIO@PL and PRATIO@PL, values obtained similarly with the previous calibration processing may be held as the ERATIO@PL and PRATIO@PL, or an arrangement may be made wherein values obtained with the previous calibration processing are held, and the ERATIO@PL and PRATIO@PL are calculated from the held values with the present calibration processing.

Description will be back to FIG. 32, where in step S343 the PL calibration processing unit 242 sets the indicating value of the A1DAC 133 to the EPWR so as to employ the PL as the target value as the previous processing before input of the control voltage VWDC by the AD 161 is performed, and in step S344 sets the indicating value of the A2DAC 151 to the P2PWR so as to employ the PL as the target value.

More specifically, as shown within a frame 441 in FIG. 34, the PL calibration processing unit 242 calculates a value equivalent to the PL of the target value EPWR from P2L/P2H-OP appended data to set this, and calculates a value equivalent to the PL of the target value P2PWR from P2L/P2H-OP appended data to set this.

Upon the preprocessing being ended, next in step S345, the PL calibration processing unit 242 sets the cool channel and erase channel to ON, and in step S346 performs APC control regarding the erase channel at the time of the writing processing. Subsequently, in step S347, as shown in words balloon 431 in FIG. 33, the PL calibration processing unit 242 converts the control voltage VWDC into a digital value to extract this as an EINTMON a predetermined number of times for improving precision.

In reality, as shown in words balloon 432 in FIG. 33, the PL calibration processing unit 242 only activates the scripter for repeatedly obtaining the output value EINTMON of the AD 161 at timing of BLKINT of the head of the RUB to be processed. That is to say, input of the output value EINTMON of the AD 161 is performed by the scripter thereof. The scripter, for example, repeats input of the EINTMON at the time of the writing processing ten times.

Upon the output digital value EINTMON of the AD 161 being input, in step S348 the PL calibration processing unit 242 sets the cool channel and peak channel to ON this time. That is to say, the PL calibration processing unit 242 switches the channel to be set to ON from the erase channel to the peak channel. Note that the APC control processing is continued in step S348 and thereafter. That is to say, according to the channel switching in step S348, switching is performed from APC control relating to the erase channel to APC control relating to the peak channel.

In step S349, as shown in words balloon 433 in FIG. 33, the PL calibration processing unit 242 converts the control voltage VWDC into a digital value to extract this as a PINTMON a predetermined number of times for improving precision.

In reality, as shown in words balloon 434 in FIG. 33, the PL calibration processing unit 242 only activates the scripter for repeatedly obtaining the output value PINTMON of the AD 161 at timing of BLKINT in the middle of the RUB to be processed. That is to say, input of the output value PINTMON of the AD 161 is performed by the scripter thereof. The scripter, for example, repeats input of the PINTMON at the time of the writing processing ten times.

Upon extracting the EINTMON and PINTMON, in step S350 the PL calibration processing unit 242 employs the extracted digital value group to obtain the EINTMON (EINTMON@PL) when employing the PL as the target value, and in step S351 employs the extracted digital value group to obtain the PINTMON (PINTMON@PL) when employing the PL as the target value.

More specifically, as shown within a frame 442 in FIG. 34, of the extracted ten EINTMONS, the PL calibration processing unit 242 obtains a value by rounding the average value of the eight values excluding the minimum value and maximum value, and sets the value thereof to the EINTMON@PL. Similarly, of the extracted ten PINTMONS, the PL calibration processing unit 242 obtains a value by rounding the average value of the eight values excluding the minimum value and maximum value, and sets the value thereof to the PINTMON@PL.

As described above, upon calculating the EINTMON@PL and PINTMON@PL, the PL calibration processing unit 242 ends the PL calibration processing, returns the processing to step S302 in FIG. 27, and executes the processing in step S303 and thereafter. That is to say, after being awaited for a predetermined period, the PL calibration processing is started.

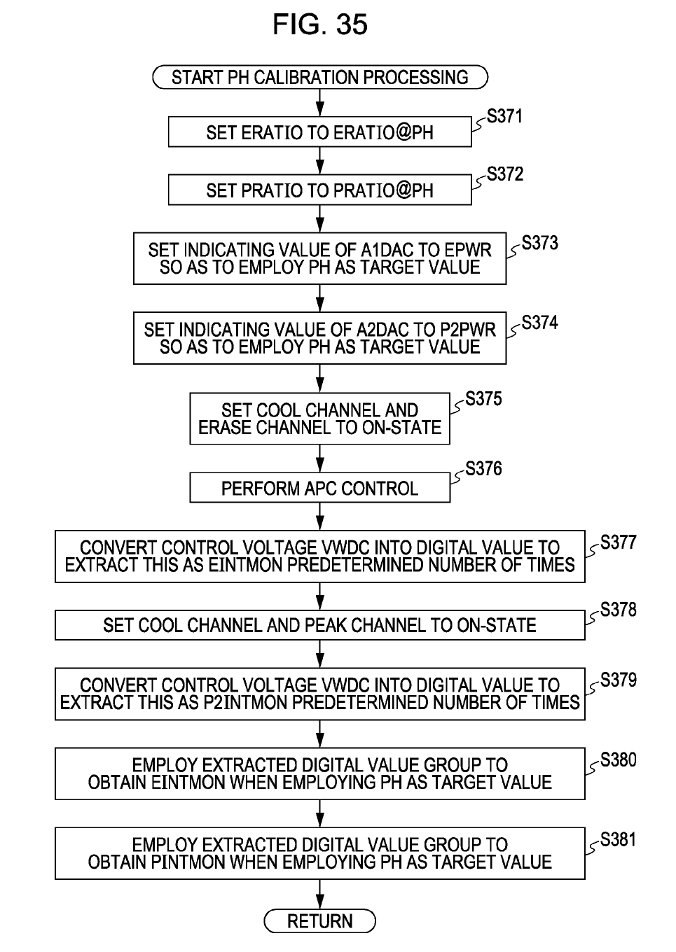

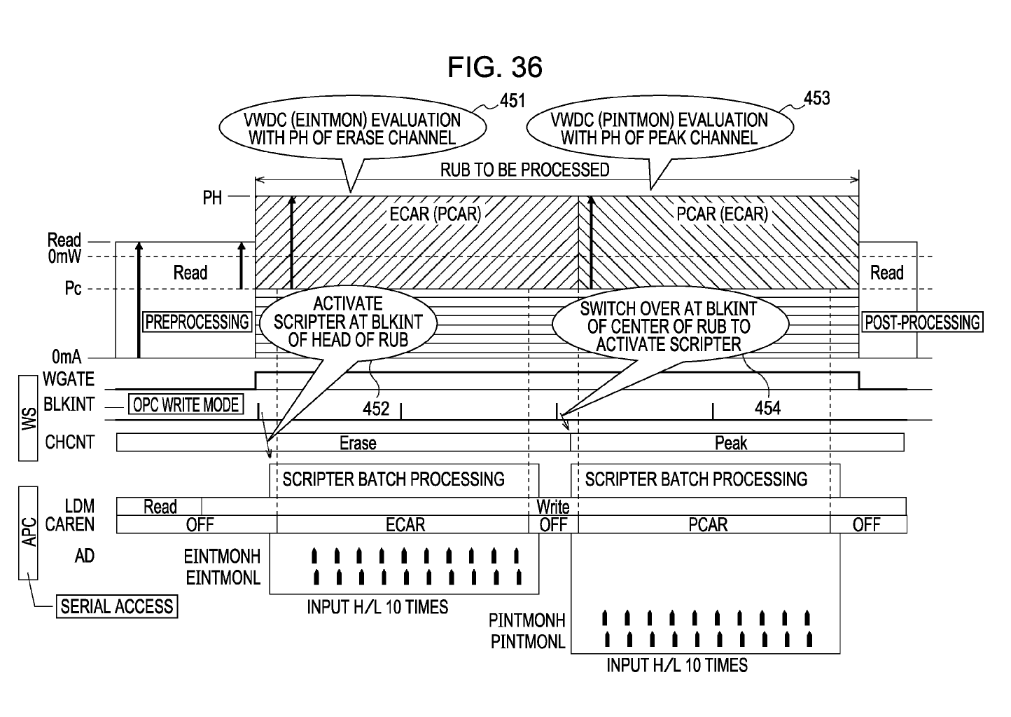

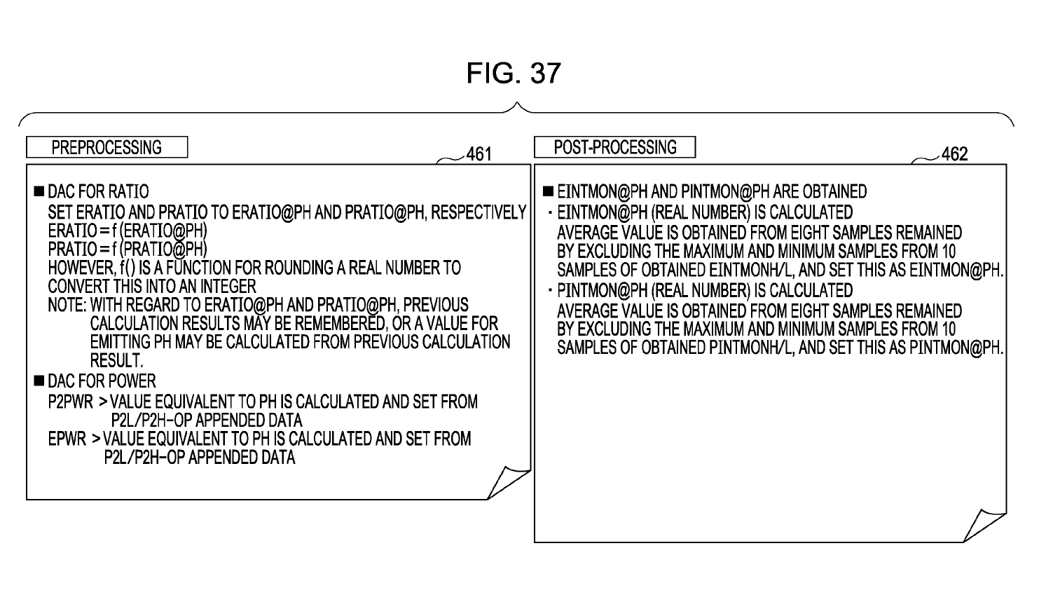

Next, the details of the PH calibration processing executed in step S304 in FIG. 27 will be described with reference to the flowchart in FIG. 35. Description will be made with reference to FIGS. 36 and 37 as appropriate. FIG. 36 is a schematic view illustrating a situation example of the PH calibration processing. FIG. 37 is a diagram for describing the details of the content of the PH calibration processing.

As preprocessing before input of the control voltage VWDC by the AD 161 is performed, in step S371 the PH calibration processing unit 244 sets the indicating value ERATIO of the C1DAC 155 to the ERATIO@PH calculated with the previous PH calibration processing, and in step S372 sets the indicating value PRATIO of the C2DAC 156 to the PRATIO@PH calculated with the previous PH calibration processing.

More specifically, as shown within a frame 461 in FIG. 37, the ERATIO@PH and PRATIO@PH calculated with the previous PH calibration processing are rounded and converted into integers. Note that, with regard to the ERATIO@PH and PRATIO@PH, values obtained similarly with the previous calibration processing may be held as the ERATIO@PH and PRATIO@PH, or an arrangement may be made wherein values obtained with the previous calibration processing are held, and the ERATIO@PH and PRATIO@PH are calculated from the held values with the present calibration processing.

Description will be back to FIG. 35, where in step S373 the PH calibration processing unit 244 sets the indicating value of the A1DAC 133 to the EPWR so as to employ the PH as the target value as the previous processing before input of the control voltage VWDC by the AD 161 is performed, and in step S374 sets the indicating value of the A2DAC 151 to the P2PWR so as to employ the PH as the target value.

More specifically, as shown within a frame 441 in FIG. 37, the PH calibration processing unit 244 calculates a value equivalent to the PH of the target value EPWR from P2L/P2H-OP appended data to set this, and calculates a value equivalent to the PH of the target value P2PWR from P2L/P2H-OP appended data to set this.

Upon the preprocessing being ended, next in step S375, the PH calibration processing unit 244 sets the cool channel and erase channel to ON, and in step S376 performs APC control regarding the erase channel at the time of the writing processing. Subsequently, in step S377, as shown in words balloon 451 in FIG. 36, the PH calibration processing unit 244 converts the control voltage VWDC into a digital value to extract this as an EINTMON a predetermined number of times for improving precision.

In reality, as shown in words balloon 452 in FIG. 36, the PH calibration processing unit 244 only activates the scripter for repeatedly obtaining the output value EINTMON of the AD 161 at timing of BLKINT of the head of the RUB to be processed. That is to say, input of the output value EINTMON of the AD 161 is performed by the scripter thereof. The scripter, for example, repeats input of the EINTMON at the time of the writing processing ten times.

Upon the output digital value EINTMON of the AD 161 being input, in step S378 the PH calibration processing unit 244 sets the cool channel and peak channel to ON this time. That is to say, the PH calibration processing unit 244 switches the channel to be set to ON from the erase channel to the peak channel. Note that the APC control processing is continued in step S378 and thereafter. That is to say, according to the channel switching in step S378, switching is performed from APC control relating to the erase channel to APC control relating to the peak channel.

In step S379, as shown in words balloon 453 in FIG. 36, the PH calibration processing unit 244 converts the control voltage VWDC into a digital value to extract this as a PINTMON a predetermined number of times for improving precision.

In reality, as shown in words balloon 454 in FIG. 36, the PH calibration processing unit 244 only activates the scripter for repeatedly obtaining the output value PINTMON of the AD 161 at timing of BLKINT in the middle of the RUB to be processed. That is to say, input of the output value PINTMON of the AD 161 is performed by the scripter thereof. The scripter, for example, repeats input of the PINTMON at the time of the writing processing ten times.

Upon extracting the EINTMON and PINTMON, in step S380 the PH calibration processing unit 244 employs the extracted digital value group to obtain the EINTMON (EINTMON@PH) when employing the PH as the target value, and in step S381 employs the extracted digital value group to obtain the PINTMON (PINTMON@PH) when employing the PH as the target value.

More specifically, as shown within a frame 462 in FIG. 37, of the extracted ten EINTMONS, the PH calibration processing unit 244 obtains a value by rounding the average value of the eight values excluding the minimum value and maximum value, and sets the value thereof to the EINTMON@PH. Similarly, of the extracted ten PINTMONS, the PH calibration processing unit 244 obtains a value by rounding the average value of the eight values excluding the minimum value and maximum value, and sets the value thereof to the PINTMON@PH.

As described above, upon calculating the EINTMON@PH and PINTMON@PH, the PH calibration processing unit 244 ends the PH calibration processing, returns the processing to step S304 in FIG. 27, and executes the processing in step S305 and thereafter.

In step S305, in the same way as in steps S6 (erase-channel two-point calibration phase-2 processing) and S7 (peak-channel two-point calibration phase-2 processing) of the initial calibration processing, the RATIO correction processing unit 245 corrects the ERATIO@PL to update this to the latest value by employing Expression (11), corrects the ERATIO@PH to update this to the latest value by employing Expression (12), corrects the PRATIO@PL to update this to the latest value by employing Expression (14), and corrects the PRATIO@PH to update this to the latest value by employing Expression (15).

Subsequently, in step S306, in the same way as in the case of step S8 of the initial calibration processing, the RATIO setting processing unit 246 calculates and sets the ERATIO@WR by employing Expression (13), and calculates and sets the PRATIO@WR by employing Expression (16).

As described above, the operating calibration processing unit 222 can perform the calibration processing while tracing the optical disc 21.

Note that description has been made so far wherein with calibration of control of the cool channel, erase channel, and peak channel, the two-point calibration processing is preformed wherein APC is executed by employing predetermined two points (PL and PH) as the target values, the relation between the target values and control voltage is obtained from the results of the two points thereof, and the control voltage corresponding to a desired target value is calculated based on the relation thereof, but as long as the number of target values for obtaining control voltage at the time of the calibration processing is two or more, for example, control voltage may be obtained regarding three or more target values.

Also, description has been made so far wherein control voltage is extracted as a digital value in the case of the target value is the PL and in the case of the target value is the PH, and with a graph wherein the horizontal axis is a target value, and the vertical axis is extraction results (an indicating value of the D/A converter), extracted two points are connected with a straight line, and the indicating value of the D/A converter corresponding to a desired target value is obtained on the straight line thereof, but a straight line representing the relation between a target value and an indicating value of the D/A converter may be obtained with any kind of method, for example, may be obtained with the least square method. Also, the relation between a target value and an indicating value of the D/A converter is not restricted to a straight line, and may be represented with a curve.

Note that description has been made so far regarding the optical disc drive 10, but the present invention can be applied to any kind of device or system as long as it includes an APC system for controlling the emission power of a laser beam.

As described above, the CPU 31 controls the LD 111 to emit and output a laser beam with a plurality of power which are mutually different, controls the AD 141 or AD 161 of the APC 113 to detect the control voltage corresponding to each power, obtains the relation between the control voltage thereof and the target value of the power thereof, and performs calibration processing (multiple-point calibration) for adjusting the control voltage (the indicating value for setting the control voltage) corresponding to the target power in accordance with the relation thereof, whereby the calibration processing can be performed in a precise manner.

Also, the CPU 31 subjects a part or all of the multiple channels included in the APC 113 to such calibration processing for each channel one at a time, whereby the calibration processing of the control voltage (the indicating value for setting the control voltage) of each channel can be performed in a precise manner.

The LDD 114 converts the control voltage of each channel of the APC 113 into current, builds up this, and supplies this, thereby controlling the LD 111 to emit and output a laser beam with power according to the current value thereof. Also, the LDD 114 can control the LD 111 to emit a laser beam with a plurality of power by changing the method for building up current thereof. With such a system, as described above, the CPU 31 performs the calibration processing of the control voltage of each channel in a precise manner, whereby the CPU 31 can control the APC 113 in a precise manner even in a case wherein the LD 111 emits a laser beam with which power.

In order to obtain the relation between the control voltage and target value of the power thereof, the CPU 31 controls the AD 141 or AD 161 to detect the target value and control voltage (the indicating value of a current value) by emitting a laser beam with two mutually different target values to perform APC control, obtains a straight line connecting two points made up of a combination of the indicating value and target value (power) based on the two detection results, and obtains the indicating value corresponding to the target value on the straight line thereof, thereby readily performing high-precision calibration processing.

Also, the CPU 31 controls current on another channel which is not an object of the calibration processing of the APC 113 in the same way as in the case of normal operation (reading processing and writing processing) at the time of performing the calibration processing for each channel. Thus, the CPU 31 can perform the calibration processing in a state close to the actual operation regarding gain errors of a circuit, offset, and so forth, whereby high-precision calibration processing can be realized. Note that, according to such a method, for example, even in a case wherein it is difficult to improve circuit precision such that the entire system is made up of multiple circuits configured as mutually separate components, the calibration processing can be readily performed so as to improve the precision of control processing, whereby a system design can be facilitated.

The APC system included in the optical head unit of the optical disc drive device is subjected to such calibration processing, whereby the power of a laser beam irradiated on an optical disc for reading or writing of information as to the optical disc can be controlled in a precise manner. With such an optical disc drive device, an LD emits and outputs a laser beam with read power, cool power, erase power, peak power, or the like, but the CPU 31 can perform the calibration of the APC for controlling each power in a precise manner.

The initial calibration processing unit 221 performs the above-mentioned calibration processing before the optical head unit traces the optical disc (before starting reading processing or writing processing). Thus, the APC of the optical head unit can perform high-precision APC control from the start of the reading processing or writing processing.

The VRDC extraction processing unit 231 performs extraction of the control voltage while allowing the APC 113 to perform control operation at the time of read power emission of the reading processing, whereby high-precision calibration processing can be performed in a state closer to the actual operation.

The cool-channel two-point calibration processing unit 232 performs multiple-point calibration relating to the control of the cool channel while allowing the APC 113 to perform control operation at the time of cool power emission of the writing processing. Thus, the cool-channel two-point calibration processing unit 232 not only can perform the calibration of the control of the cool channel in a more precise manner but also can improve the precision of erase power or peak power employing cool power.

The erase channel and peak channel share the D/A converter for supplying the initial value of control voltage, and each of the channels includes a D/A converter for RATIO (C1DAC 155 and C2DAC 156). The peak-channel two-point calibration phase-1 processing unit 235 and peak-channel two-point calibration phase-2 processing unit 237 subject the erase channel and peak channel to multiple-point calibration respectively, whereby both of the control of erase power and the control of peak power can be calibrated in a precise manner.

The erase-channel two-point calibration phase-1 processing unit 234 and erase-channel two-point calibration phase-2 processing unit 236 subject the erase channel to the calibration processing multiple times, and the peak-channel two-point calibration phase-1 processing unit 235 and peak-channel two-point calibration phase-2 processing unit 237 subject the peak channel to the calibration processing multiple times. Thus, the erase-channel two-point calibration phase-1 processing unit 234 through peak-channel two-point calibration phase-2 processing unit 237 can perform the calibration processing in a precise manner.

The full-scale evaluation processing unit 233 sets the value of the B3DAC 162 which is a D/A converter for supplying the initial value of the control voltage of the erase channel and peak channel so as to employ the resolution of the D/A converter for RATIO (C1DAC 155 and C2DAC 156) as efficiently as possible. Thus, the resolution of the settings of RATIO of the erase channel and peak channel is improved, and accordingly, the erase-channel two-point calibration phase-1 processing unit 234 through peak-channel two-point calibration phase-2 processing unit 237 can perform the calibration processing in a more precise manner.

When the optical head unit is tracing the optical disc, the operating calibration processing unit 222 performs the above-mentioned calibration processing in a state of tracing the optical disc without removing the focus form the optical disc. Thus, the APC 113 of the optical head unit 16 can absorb variations due to temperature or timekeeping such as η of the LD 111 or the like with APC control, and accordingly, high-precision APC control can be performed. Also, the calibration processing can be performed at high speed.

The PL calibration processing unit 242 and PH calibration processing unit 244 performs the calibration of the ERATIO and PRATIO by the calibration processing at the time of operation. At this time, the PL calibration processing unit 242 and PH calibration processing unit 244 employ the ERATIO and PRATIO calibrated by the previous calibration at the time of operation to perform only the phase 2 processing of the initial calibration processing. Thus, the PL calibration processing unit 242 and PH calibration processing unit 244 can increase the processing speed of the calibration processing at the time of operation.

The PL calibration processing unit 242 and PH calibration processing unit 244 both subject the same RUB to the calibration processing, but in order to reduce history effects, upon the calibration processing by the PL calibration processing unit 242 being ended, the stand-by processing unit 243 rotates the optical disc 21 once, and then controls the PH calibration processing unit 244 to execute the calibration processing.

With each calibration processing, the PL calibration processing unit 242 and PH calibration processing unit 244 perform extraction of the EINTMON and PINTMON multiple times respectively, and set the average of a part of the multiple extraction results to the EINTMON and PINTMON. Thus, multiple samples are extracted, whereby variation caused by the optical disc 21 rotating, and so forth can be absorbed, and accordingly, the PL calibration processing unit 242 and PH calibration processing unit 244 can perform the calibration processing in a more precise manner.

Note that, in order to perform calibration in a trace state, it is desirable to perform the same handling as at the time of normal writing processing in the case of an exception such as an off-track state or the like. The present method is basically processing similar to DC erase processing, so the same handling as that during a normal write/erase can be performed in the case of an exception. If the channel control by the LDD is performed forcibly with a serial interface, it becomes difficult to discontinue write/erase operation to return to read operation in a hardware manner when an exception occurs. With the present proposal, ON/OFF of a channel is controlled with a channel control signal from a WS block, whereby calibration operation can be discontinued with the same hardware signal as at the time of a normal write/erase.

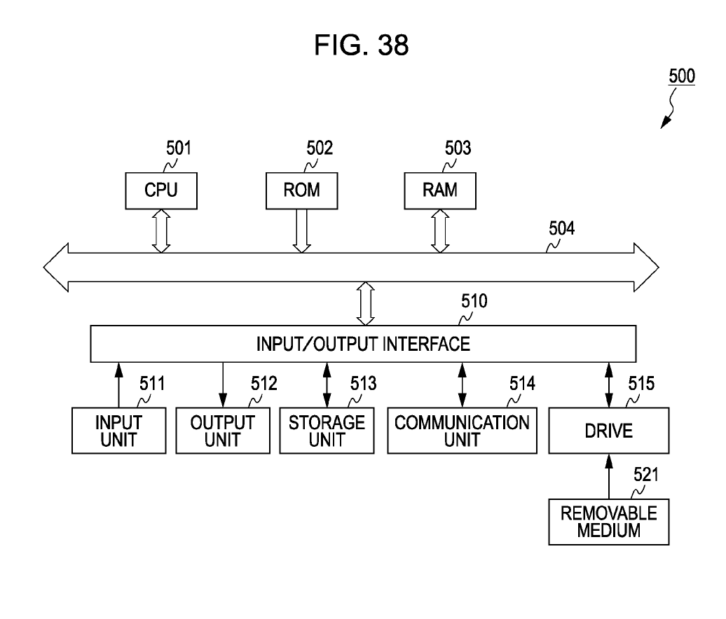

The above-mentioned series of processing can be executed not only by hardware but also by software. This case may be configured as a personal computer, for example, such as shown in FIG. 38.

In FIG. 38, a CPU 501 of a personal computer 500 executes various types of processing in accordance with a program stored in ROM 502, or a program loaded from a storage unit 513 to RAM 503. Data used for the CPU 501 executing various types of processing, and so forth are stored in the RAM 503 as appropriate. The CPU 501, ROM 502, and RAM 503 are mutually connected through a bus 504. An input/output interface 510 is also connected to this bus 504.

An input unit 511 made up of a keyboard, mouse, or the like, a display made up of a CRT (Cathode Ray Tube), LCD (Liquid Crystal Display) or the like, an output unit 512 made up of a speaker or the like, a storage unit 513 made up of a hard disk or the like, and a communication unit 514 made up of a modem or the like are connected to the input/output interface 510. The communication unit 514 performs communication processing through a network including the Internet.

A drive 515 is also connected to the input/output interface 510 as appropriate, on which a removable medium such as a magnetic disk, optical disc, magneto-optical disk, semiconductor memory, or the like is mounted as appropriate, from which a program read out is installed in the storage unit 513 as appropriate.

In the case of executing the above-mentioned series of processing by software, a program making up the software thereof is installed from a network or recording medium. This recoding medium is, for example, as shown in FIG. 38, not restricted to being configured of a removable medium 521 made up of a magnetic disk (including a flexible disk), optical disc (including a CD-ROM (Compact Disc-Read Only Memory), DVD (Digital Versatile Disc)), magneto-optical disk (including an MD (Mini Disc)), semiconductor memory, or the like, in which a program is recorded, but also may be the ROM 502 in which a program is recorded, distributed to a user in a state of being built into the device main unit, or a hard disk or the like included in the storage unit 513.

Note that, with the present Specification, steps describing a program recorded in a recording medium include not only processing performed in time sequence in accordance with the described sequence but also processing not necessarily performed in time sequence but performed in parallel or individually.

Also, with the present Specification, the term “system” represents the entire device configured of multiple devices.

Note that the configuration thus described as one device may be configured as multiple devices by being divided into multiple device. Conversely, the configuration thus described as multiple devices may be configured as one device by being collected into one device. Also, it goes without saying that a configuration other than the above-mentioned configuration may be added to the configuration of each device. Further, a part of the configuration of a certain device may be included in the configuration of another device as long as the configuration and operation as the entire system are substantially the same. That is to say, an embodiment of the present invention is not restricted to the above-mentioned embodiment, and various modifications can be performed without departing from the essence of the present invention.

It should be understood by those skilled in the art that various modifications, combinations, sub-combinations and alterations may occur depending on design requirements and other factors insofar as they are within the scope of the appended claims or the equivalents thereof.

1. An information processing device for performing calibration of an optical output level control unit for controlling an optical output level of a laser beam which an emission unit emits and outputs by a plurality of channels controlling a current value of a current supplied to said emission unit for emitting and outputting the laser beam with the optical output level according to the current value of the supplied current the information processing device comprising:
calibration means configured to perform calibration processing for each channel regarding a pan or all of said plurality of channels of said optical output level control unit wherein said emission unit is controlled to emit and output said laser beam with a plurality of different optical output levels, said optical output level control unit is controlled to detect an indicating value of said current value corresponding to each optical output level, a relation between said indicating value and said optical output level is obtained, and an indicating value corresponding to a target optical output level is adjusted in accordance with said relation.

2. The information processing device according to claim 1, wherein said calibration means control said emission unit to emit and output said laser beam with a plurality of different optical output levels, control said optical output level control unit to detect the indicating value of said current value corresponding to each optical output level, obtain the relation between said indicating value and said optical output level based on the plurality of detection results, and obtain an indicating value corresponding to a target optical output level in accordance with said relation, for each channel as said calibration processing.

3. The information processing device according to claim 1, wherein said calibration means controls another channel of said optical output level control unit which is not a target for said calibration processing to control said current with the same indicating value as that in the case at a time of normal operation when performing said calibration processing.

4. The information processing device according to claim 1, wherein said emission unit is a laser diode for irradiating a laser beam on an optical disc mounted on a predetermined position of an optical disc drive device;
and wherein said optical output level control unit controls a read optical output level which is the optical output level of said laser beam at the time of reading out information recorded in said optical disc, a cool optical output level which is the optical output level of said laser beam at the time of cooling said optical disc, an erase optical output level which is the optical output level of said laser beam at the time of erasing information recorded in said optical disc, and a peak optical output level which is the optical output level of said laser beam at the time of writing information in said optical disc, using mutually different channels;
and wherein said calibration means calibrate the indicating value corresponding to said cool optical output level, the indicating value corresponding to said erase optical output level, and the indicating value corresponding to said peak optical output level, of said optical output level control unit by said calibration processing.

5. The information processing device according to claim 4, wherein said calibration means perform said calibration processing before said emission unit starts reading processing or writing processing of said information as to said optical disc.

6. The information processing device according to claim 5, wherein said calibration means control said optical output level control unit to detect the indicating value corresponding to said read optical output level.

7. The information processing device according to claim 6, wherein said optical output level control unit calculates the indicating value corresponding to said cool optical output level by subtracting the output of a predetermined D/A converter from the indicating value corresponding to said read optical output level at a channel for controlling said cool optical output level;
and wherein said calibration means obtain the indicating value corresponding to said cool optical output level, and further subtract the indicating value corresponding to the cool optical output level thereof from the indicating value corresponding to said read optical output level detected by said optical output level control unit, thereby calculating the indicating value of said D/A converter.

8. The information processing device according to claim 7, wherein said optical output level control unit controls mutually different amplifier units employing a D/A converter to amplify the common output of said D/A converter, thereby calculating the indicating value corresponding to said erase optical output level, and the indicating value corresponding to said peak optical output level;
and wherein said calibration means control said optical output level control unit to detect each indicating value when setting the gain of said amplifier unit to a predetermined value, and control said emission unit to emit and output said laser beam with a plurality of mutually different optical output levels, at each of the channel for controlling said erase optical output level, and the channel for controlling said peak optical output level.

9. The information processing device according to claim 8, wherein said calibration means control said emission unit to emit and output said laser beam with the same plurality of optical output levels as those last time while setting the gain of said amplifier unit to a value equivalent to each detected indicating value, thereby performing calibration processing again.

10. The information processing device according to claim 8, wherein said calibration means detect the indicating value corresponding to said erase optical output level in a state in which the gain of said amplifier unit is set to the maximum at a channel for controlling said erase optical output level, and set a value equivalent to the detected indicating value corresponding to said erase optical output level to the gain of said amplifier unit as said predetermined value.

11. The information processing device according to claim 4, wherein said calibration means perform said calibration processing while said emission unit performs reading processing or writing processing of said information as to said optical disc to calibrate the indicating value corresponding to said erase optical output level, and the indicating value corresponding to said peak optical output level, of said optical output level control unit.

12. The information processing device according to claim 11, wherein said optical output level control unit controls mutually different amplifier units employing a D/A converter to amplify the common output of said D/A converter, thereby calculating the indicating value corresponding to said erase optical output level, and the indicating value corresponding to said peak optical output level;
and wherein said calibration means control said emission unit to emit and output said laser beam with the same plurality of optical output levels those in the previous calibration processing, while controlling said optical output level control unit to set the gain of said amplifier unit to a value equivalent to each indicating value detected at the previous calibration processing, at each of the channel for controlling said erase optical output level and the channel for controlling said peak optical output level, thereby performing calibration processing.

13. The information processing device according to claim 12, wherein said calibration means detect said indicating values when controlling said emission unit to irradiate said laser beam on a predetermined area of said optical disc with a first optical output level, await while said optical disc rotates once, detect said indicating values when controlling said emission unit to irradiate said laser beam with a second optical output level, and adjust each of the indicating values corresponding to said peak optical output level and said erase optical output level from the relation between each detected indicating value and said optical output level, as said calibration processing.

14. The information processing device according to claim 13, wherein said calibration means control said optical output level control unit to detect said indicating values a plurality of times, thereby setting the average value of a plurality of detected values excluding the maximum value and minimum value as a detected indicating value.

15. An information processing method for an information processing device for performing calibration of an optical output level control unit for controlling an optical output level of a laser beam which an emission unit emits and outputs by a plurality of channels controlling a current value of a current supplied to said emission unit for emitting and outputting the laser beam with the optical output level according to the current value of the current, comprising, for each channel regarding a part or all of said plurality of channels of said optical output control unit, steps of:
controlling said emission unit to emit and output said laser beam with a plurality of mutually different optical output levels;
controlling said optical output level control unit to detect an indicating value of said current value corresponding to each optical output level;
obtaining a relation between said indicating value and said optical output level; and
adjusting the indicating value corresponding to a target optical output level in accordance with said relation.

16. A program causing a computer, which performs calibration of an optical output level control unit for controlling an optical output level of a laser beam which an emission unit emits and outputs by a plurality of channels controlling a current value of a current supplied to said emission unit for emitting and outputting the laser beam with the optical output level according to the current value of the current, to execute information processing comprising, for each channel regarding a part or all of said plurality of channels of said optical output level control unit, steps of:
controlling said emission unit to emit and output said laser beam with a plurality of mutually different optical output levels;
controlling said optical output level control unit to detect an indicating value of said current value corresponding to each optical output level;
obtaining a relation between said indicating value and said optical output level; and
adjusting the indicating value corresponding to a target optical output level in accordance with said relation.

17. An information processing device for performing calibration of an optical output level control unit for controlling an optical output level of a laser beam which an emission unit emits and outputs by a plurality of channels controlling a current value of current supplied to said emission unit for emitting and outputting the laser beam with the optical output level according to the current value of the supplied current, the information processing device comprising:
a calibration unit configured to perform calibration processing for each channel regarding a part or all of said plurality of channels of said optical output level control unit wherein said emission unit is controlled to emit and output said laser beam with a plurality of different optical output levels, said optical output level control unit is controlled to detect the indicating value of said current value corresponding to each optical output level, the relation between said indicating value and said optical output level is obtained, and an indicating value corresponding to a target optical output level is adjusted in accordance with said relation.
